(19) United States
(12) Patent Application Publication
(10) Pub. No.: US 2022/0012496 A1
(43) Pub. Date: Jan. 13, 2022

(54) SECURITY SYSTEM AND SECURITY METHOD

(71) Applicant: PANASONIC I-PRO SENSING SOLUTIONS CO., LTD., Fukuoka (JP)

(72) Inventors: Minoru HAGIO, Fukuoka (JP); Keiichi MIYAZAKI, Fukuoka (JP); Nobuhito SEKI, Fukuoka (JP)

(21) Appl. No.: 17/283,917

(22) PCT Filed: Jul. 22, 2019
(86) PCT No.: PCT/JP2019/028590

§ 371 Date: Apr. 8, 2021

(30) Foreign Application Priority Data
Oct. 12, 2018 (JP) 2018-193520
Nov. 27, 2018 (JP) 2018-221120
Nov. 27, 2018 (JP) 2018-221127

(51) Int. Cl. G06K 9/00; G06Q 50/26; B64C 39/02

(52) U.S. Cl. CPC G06K 9/00671; G06K 9/00288; B64C 2201/123; B64C 39/024; G06K 2009/00738; G06Q 50/26

(57) ABSTRACT

A security system according to the present invention comprises: a wearable camera that can be worn by a person and can record a first image which has been captured; an unmanned aerial vehicle that can record a second image which has been captured by a camera mounted thereon; and a control device that acquires the position of the wearable camera and transmits a first instruction to the unmanned aerial vehicle to start recording the second image and to move toward the position of the wearable camera.

### TECHNICAL FIELD

The present disclosure relates to a security system and a security method.

### BACKGROUND ART

In recent years, an in-vehicle camera system (ICV: In Car Video system) mounted on a patrol car and a wearable camera (BWC: Body-Worn Camera) mounted on a uniform of a police officer are used to image and record a site of an event or an accident. For example, PTL 1 discloses the following system. That is, the BWC captures an image of a front side of the police officer and transmits captured image data to the ICV. The ICV stores image data captured by the in-vehicle camera and the image data transmitted from the BWC.

In recent years, it has also been considered to use an unmanned aerial vehicle (drone) to image and record a site of an event or an accident. For example, PTL 2 discloses the fact that a drone moves to an accident site and then images and records the accident site.

### CITATION LIST

### Patent Literature

[PTL 1]: JP-A-2018-42229

[PTL 2]: JP-A-2018-110304

[PTL 3]: WO 2018/083798

### SUMMARY OF INVENTION

### Technical Problem

However, since the site of the event or the accident requires an urgent response, it is not preferable that a work load of a police officer or the like at the site is increased due to imaging and/or recording of the site performed by the unmanned aerial vehicle.

Non-limiting embodiments of the present disclosure contribute to a security system and a security method that perform imaging and/or recording of a site by an unmanned aerial vehicle while reducing a work load of a police officer or the like at the site.

### Solution to Problem

A security system according to one aspect of the present disclosure includes: a wearable camera, which is wearable by a person and is capable of recording an captured first image; an unmanned aerial vehicle capable of recording a second image captured by a camera mounted thereon; and a control device which acquires a position of the wearable camera and transmits a first instruction to the unmanned aerial vehicle. The first instruction indicates start of the recording of the second image and movement toward the position of the wearable camera.

It should be noted that these comprehensive or specific aspects may be realized by a system, a method, an integrated circuit, a computer program, or a recording medium, or may be realized by any combination of the system, a device, the method, the integrated circuit, the computer program, and the recording medium.

### Advantageous Effects of Invention

According to the present disclosure, the imaging and/or the recording of the site can be performed by a drone while the work load of the police officer at the site is reduced.

Further, advantages and effects of the one aspect of the present invention will become apparent from the specification and the drawings. These advantages and/or effects are provided by features described in several embodiments and the specification and drawings, and it is not necessary to provide all the features to obtain one or more identical features.

### BRIEF DESCRIPTION OF DRAWINGS

FIG. 1 shows a configuration example of a security system according to Embodiment 1.

FIG. 2 shows a configuration example of a BWC according to Embodiment 1.

FIG. 3 shows a configuration example of a drone according to Embodiment 1.

FIG. 4 shows a configuration example of an ICV according to Embodiment 1.

FIG. 5 is a sequence chart showing an example of a drone take-off process according to Embodiment 1.

FIG. 6 is a sequence chart showing a modification of the drone take-off process according to Embodiment 1.

FIG. 7 is a sequence chart showing an example of a target tracking process according to Embodiment 1.

FIG. 8 is a sequence chart showing an example of a drone landing process according to Embodiment 1.

FIG. 9 is a sequence chart showing an example of a recorded data management process according to Embodiment 1.

FIG. 10 shows a configuration example of a security system according to Embodiment 2.

FIG. 11 is a sequence chart showing an example of a process according to Embodiment 2.

FIG. 12 is a sequence chart showing a modification of the process according to Embodiment 2.

FIG. 13 shows a configuration example of a security system according to Embodiment 3.

FIG. 14 is a sequence chart showing an example of a process according to Embodiment 3.

FIG. 15 shows a configuration example of a security system according to Embodiment 4.

FIG. 16 shows an example of a drone UI in a case where a drone according to Embodiment 4 is in a patrol mode.

FIG. 17 shows an example of a drone UI in a case where the drone according to Embodiment 4 is in a manual mode.

FIG. 18 shows an example of a drone UI in a case where the drone according to Embodiment 4 is in a tracking mode.

FIG. 19 is a sequence chart showing an example of a process according to Embodiment 4.

FIG. 20 shows a configuration example of a tracking system according to Embodiment 5.

FIG. 21 shows a block configuration example of a base station according to Embodiment 5.

FIG. 22 shows a block configuration example of an unmanned aerial vehicle according to Embodiment 5.

FIG. 23 is a sequence chart showing an operation example of the tracking system according to Embodiment 5.

FIG. 24 shows a configuration example of a patrol system according to Embodiment 6.

FIG. 25A is a sequence chart showing an operation example of the patrol system according to Embodiment 6.

FIG. 25B is a sequence chart showing an operation example of the patrol system according to Embodiment 6.

FIG. 26 shows a configuration example of a patrol system according to Embodiment 7.

FIG. 27A shows a schematic operation example of the patrol system according to Embodiment 7.

FIG. 27B shows a schematic operation example of the patrol system according to Embodiment 7.

FIG. 28 shows a block configuration example of a vehicle CB according to Embodiment 7.

FIG. 29 shows a block configuration example of an information processing device according to Embodiment 7.

FIG. 30 is a sequence chart showing an operation example of the patrol system according to Embodiment 7.

FIG. 31 shows a block configuration example of a wearable camera according to Embodiment 7.

FIG. 32 shows an example of appearance of an unmanned aerial vehicle according Embodiment 8.

FIG. 33 is a flowchart showing an operation example of the unmanned aerial vehicle according to Embodiment 8.

### DESCRIPTION OF EMBODIMENTS

Hereinafter, embodiments of the present disclosure will be described in detail with reference to the drawings as appropriate. However, unnecessarily detailed description may be omitted. For example, detailed description of well-known matters and redundant description of substantially the same configuration may be omitted. This is to avoid unnecessary redundancy of the following description and to facilitate understanding of those skilled in the art.

The accompanying drawings and the following description are provided for those skilled in the art to fully understand the present disclosure, and are not intended to limit the subject matter described in the claims.

### Embodiment 1

<System Configuration>

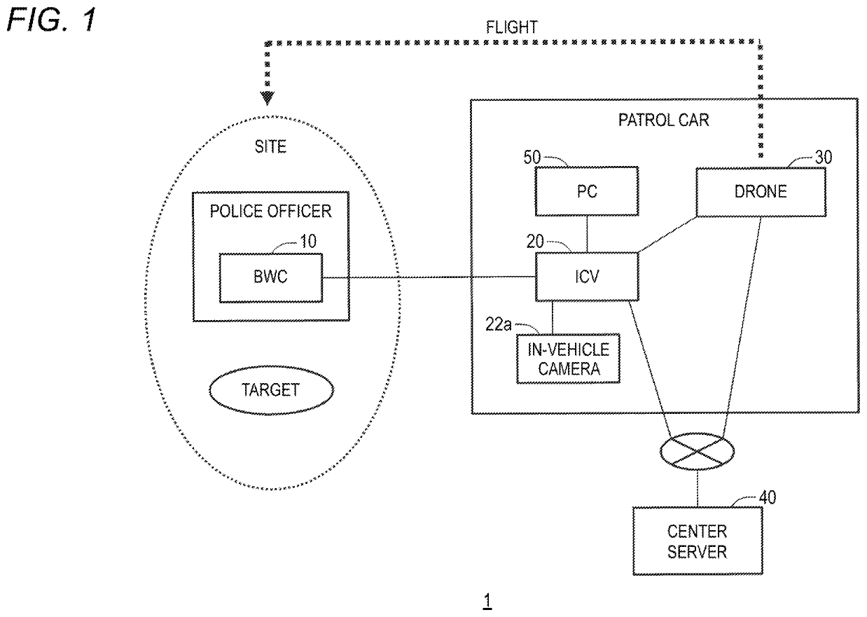

FIG. 1 shows a configuration example of a security system 1 according to Embodiment 1. The security system 1 shown in FIG. 1 includes a BWC 10, an ICV 20, an in-vehicle camera 22a, a drone 30, a center server 40, and a PC 50. The BWC 10 is worn or carried by, for example, a police officer. The ICV 20 and the drone 30 are provided in, for example, a patrol car. The center server 40 is installed, for example, in a police station.

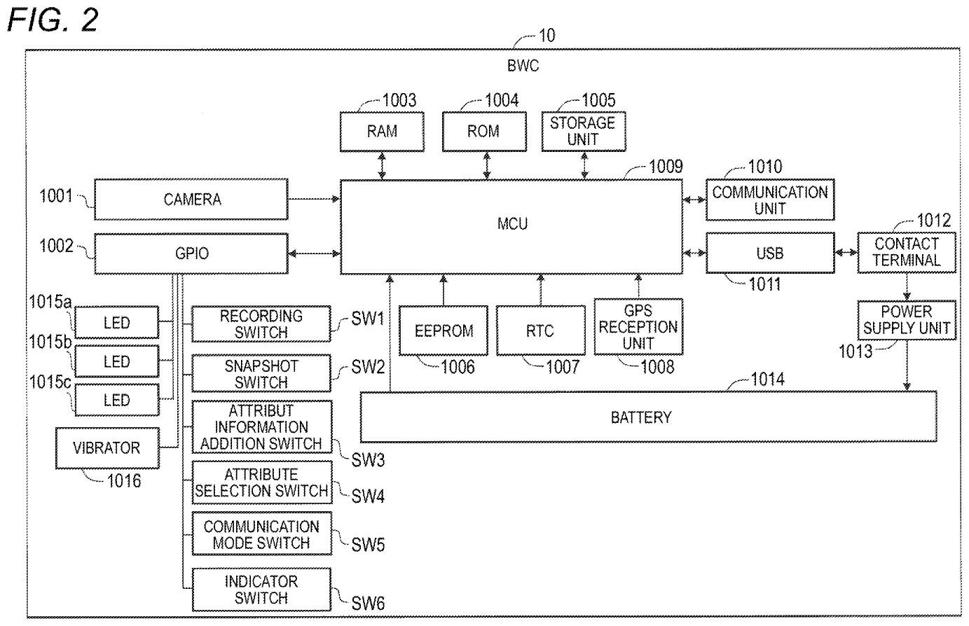

Next, an example of a configuration of the BWC 10 will be described with reference to FIG. 2.

As shown in FIG. 2, the BWC 10 includes a camera 1001, a general purpose input/output (GPIO) 1002, a random access memory (RAM) 1003, a read only memory (ROM) 1004, and a storage unit 1005. The BWC 10 includes an electrically erasable programmable ROM (EEPROM) 1006, a real time clock (RTC) 1007, and a global positioning system (GPS) reception unit 1008. The BWC 10 includes a micro controller unit (MCU) 1009, a communication unit 1010, a universal serial bus (USB) 1011, a contact terminal 1012, a power supply unit 1013, and a battery 1014.

The BWC 10 includes, as an example of an operation input unit, a recording switch SW1, a snapshot switch SW2, an attribute information addition switch SW3, an attribute selection switch SW4, a communication mode switch SW5, and an indicator switch SW6.

The BWC 10 includes, as an example of a state display unit, light emitting diodes (LED) 1015a, 1015b, and 1015c, and a vibrator 1016..

The camera 1001, which is an example of an imaging unit, includes, for example, an imaging lens and a solid-state imaging element such as a charge coupled device (CCD) type image sensor or a complementary metal oxide semiconductor (CMOS) type image sensor. The camera 1001 outputs captured image data of a subject to the MCU 1009.

The GPIO 1002 is a parallel interface which inputs and outputs signals between the recording switch SW1, the snapshot switch SW2, the attribute information addition switch SW3, the attribute selection switch SW4, the communication mode switch SW5, the indicator switch SW6, the LEDs 1015a to 1015c, the vibrator 1016, and the MCU 1009. Further, for example, various sensors (for example, an acceleration sensor) are connected to the GPIO 1002.

The RAM 1003 is, for example, a work memory used during an operation of the MCU 1009. The ROM 1004 is, for example, a memory that stores in advance programs and data for controlling the MCU 1009.

The storage unit 1005 is configured by, for example, a storage medium such as an SD memory, and stores image data captured by the camera 1001. When the SD memory is used as the storage unit 1005, the storage unit 1005 can be attached to and detached from a housing body of the BWC 10.

The EEPROM 1006 stores, for example, identification information (for example, a serial number serving as a camera ID) for identifying the BWC 10 and other setting information. The other setting information includes, for example, login information (for example, a car ID or an officer ID) obtained by setting registration in a PC in the police station or by logging in to the ICV 20, and correspondence information indicating correspondence between a state of the attribute selection switch SW4 and attribute information.

The RTC 1007 counts current time information and outputs the current time information to the MCU 1009.

The GPS reception unit 1008 receives, from a GPS transmitter (not shown), current position information of the BWC 10 and time information, and then outputs the received information to the MCU 1009. The time information is used to correct a system time of the BWC 10.

The MCU 1009 has a function of a control unit, performs, for example, a control process for controlling an overall operation of each unit of the BWC 10, a data input and output process with respect to each unit of the BWC 10, a data calculation process, and a data storage process, and operates according to the programs and data stored in the ROM 1004. The MCU 1009 uses, for example, the RAM 1003 to obtain the current time information from the RTC 1007 and obtain the current position information from the GPS reception unit 1008 at the time of operation. In the following description, an operation of the BWC 10 may also be realized by processing of the MCU 1009.

The communication unit 1010 specifies a connection between the communication unit 1010 and the MCU 1009 in a physical layer, which is a first layer of an open systems interconnection (OSI) reference model, for example. The communication unit 1010 performs, for example, wireless communication (for example, Wi-Fi (registered trademark)) using a wireless LAN (W-LAN) in accordance with such specification. The communication unit 1010 may also perform wireless communication such as near field communication (NFC) and Bluetooth (registered trademark).

The USB 1011 is a serial bus, which enables connection with the ICV 20 or a PC in the station, for example.

The contact terminal 1012 is a terminal configured to be electrically connected to a cradle (not shown), an external adapter (not shown), or the like. The contact terminal 1012 is connected to the MCU 1009 via the USB 1011, and is connected to the power supply unit 1013. Via the contact terminal 1012, the BWC 10 can be charged and communication of data including image data is enabled.

The contact terminal 1012 is provided with, for example, a “charge terminal V+”, a “CON.DET terminal”, “data terminals D−, D+” and a “ground terminal” (all of which are not shown). The CON.DET terminal is a terminal used for detecting a voltage and a voltage change. The data terminals D− and D±are terminals for transferring image data or the like captured by the BWC 10 to an external PC or the like via, for example, a USB connector terminal.

When the contact terminal 1012 is connected to a connector of the cradle (not shown) or the external adapter (not shown), data communication can be performed between the BWC 10 and an external device.

For example, the power supply unit 1013 supplies power supply power supplied from the cradle or the external adapter via the contact terminal 1012 to the battery 1014 so as to charge the battery 1014. The battery 1014 is configured by, for example, a rechargeable secondary battery, which supplies power supply power to each unit of the BWC 10.

The recording switch SW1 is, for example, a push button switch for inputting an operation instruction by a push down operation of the police officer to start or stop recording (capturing of a moving image).

The snapshot switch SW2 is, for example, a push button switch for inputting an operation instruction by a push down operation of the police officer to capture a still image.

The attribute information addition switch SW3 is, for example, a push button switch for inputting an operation instruction by a push down operation of the police officer to add. attribute information to image data.

The attribute selection switch SW4 is, for example, a slide switch for inputting an operation instruction to select an attribute to be added to the image data.

The communication mode switch SW5 is, for example, a slide switch for inputting an operation instruction to set a communication mode between the BWC 10 and the external device.

The indicator switch SW6 is, for example, a slide switch for inputting an operation instruction to set an operation state display mode of the LEDs 1015a to 1015c and the vibrator 1016.

The recording switch SW1, the snapshot switch SW2, the attribute information addition switch SW3, and the attribute selection switch SW4 are configured to be easily operable even during an emergency. It should be noted that each of the switches SW1 to SW6 is not limited to the above-described form, and may also be an operation input device of any other form that allows an operation instruction to be input by a user.

The LED 1015a is a display unit that indicates, for example, a power supply state (on/off state) of the BWC 10 and a state of the battery 1014.

The LED 1015b is, for example, a display unit that indicates a state of an image capturing operation (recording state) of the BWC 10.

The LED 1015c is, for example, a display unit that indicates a state of the communication mode of the BWC 10.

The MCU 1009 performs input detection of each of the recording switch SW1, the snapshot switch SW2, the attribute information addition switch SW3, the attribute selection switch SW4, the communication mode switch SW5, and the indicator switch SW6, and performs processing in response to switch input that has been operated.

When the MCU 1009 detects an operation input of the recording switch SW1, the MCU 1009 controls start or stop of an image capturing operation of the camera 1001, and stores image data obtained from the camera 1001 in the storage unit 1005 as image data of a moving image.

When the MCU 1009 detects an operation input of the snapshot switch SW2, the MCU 1009 stores image data obtained by the camera 1001 when the snapshot switch SW2 is operated in the storage unit 1005 as image data (recorded data) of a still image.

When the MCU 1009 detects an operation input of the attribute information addition switch SW3, the MCU 1009 adds preset attribute information to the image data and stores the attribute information in the storage unit 1005 in association with the image data. At this time, correspondence information indicating a correspondence relationship between a state of the attribute selection switch SW4 and predetermined attribute information is held in the EEPROM 1006. The MCU 1009 detects the state of the attribute selection switch SW4 and adds the attribute information in accordance with setting of the attribute selection switch SW4.

The MCU 1009 detects a state of the communication mode switch SW5, and operates the communication unit 1010 in a communication mode corresponding to setting of S the communication mode switch SW5.

When a recording operation is started, the MCU 1009 detects a state of the indicator switch SW6, and performs notification by LED display and/or vibrator vibration in accordance with setting of the indicator switch SW6 so as to indicate a state of the recording operation to the outside.

The BWC 10 records (video recording and audio recording) the image captured by the camera 1001 and a sound collected by a microphone (not shown) in the storage unit 1005. Hereinafter, video and audio data recorded in the BWC 10 will be referred to as “BWC recorded data”. As a result, in the BWC recorded data, images (and sounds) around the police officer (of a site and/or a target or the like) are recorded. The site is a place where a police officer goes in response to a request such as a report, and is, for example, an event site or an accident site The target is a person, a vehicle, or the like to be tracked by the police officer, and is, for example, an escaping criminal or an escaping vehicle.

The BWC 10 may start and stop the recording in accordance with to a manual operation of the police officer. Alternatively, the BWC 10 may automatically start and stop the recording when a predetermined condition is satisfied. The predetermined condition is, for example, a case where the BWC 10 is separated from the ICV 20 by a predetermined or more distance.

The BWC 10 may transmit the BWC recorded data to the ICV 20. That is, the BWC recorded data may be managed by the ICV 20. The BWC 10 may transmit the BWC recorded data to the ICV 20 at any time during the recording. Alternatively, the BWC 10 may transmit the BWC recorded data to the ICV 20 after the recording is stopped.

The BWC 10 may specify the current position by the GPS reception unit 1008 and transmit the specified position information (hereinafter, referred to as the “BWC position information”) to the ICV 20.

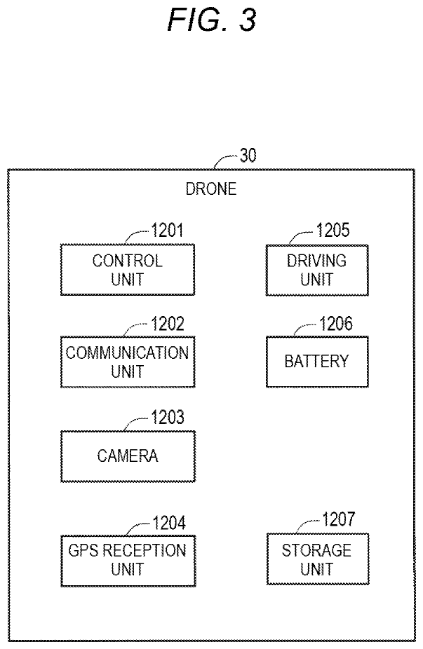

Next, an example of a configuration of the drone 30 which is an example of an unmanned aerial vehicle (UAV) will be described with reference to FIG. 3.

As shown in FIG. 3, the drone 30 includes a control unit 1201, a communication unit 1202, a camera 1203, a GPS reception unit 1204, a drive unit 1205, a battery 1206, and a storage unit 1207.

The control unit 1201 controls the drone 30 as a whole. The control unit 1201 may be configured by, for example, a CPU. In the following description, an operation of the drone 30 may be realized by processing of the control unit 1201.

The communication unit 1202 performs wireless communication with a base station (not shown). The camera 1203, which is an example of an image capturing unit, includes an optical lens, a lens control mechanism, an image sensor, and the like. The camera 1203 outputs captured image data to the control unit 1201.

The GPS reception unit 1204 receives GPS signals transmitted from a plurality of GPS satellites, and uses the received GPS signals to calculate a current position of the drone 30. The current position includes, for example, a latitude and a longitude.

The drive unit 1205 is, for example, a motor, which turns a propeller (not shown) of the drone 30 in accordance with control of the control unit 1201. The battery 1206 is a power supply of the drone 30, and is, for example, a rechargeable secondary battery.

The storage unit 1207 stores a program used for operating the control unit 1201. The storage unit 1207 also stores data used for the control unit 1201 to perform calculation processing, data used for the control unit 1201 to control each unit, or the like. The storage unit 1207 may be configured by a storage device such as a RAM, a ROM, a flash memory, or an HDD.

The drone 30 stream-transmits the image captured by the camera 1203 and a sound collected by a microphone to the ICV 20 and/or the center server 40. As a result, the ICV 20 and/or the center server 40 can output the image and the sound that are being captured and collected by the drone 30.

Upon receiving a recording start command, which is an example of a control command, the drone 30 starts recording (video recording and audio recording) of the image captured by the camera 1203 and the sound collected by the microphone. Upon receiving a recording stop command, which is also an example of the control command, the drone 30 stops the recording. Hereinafter, data of the image and the sound recorded by the drone 30 is referred to as “drone recorded data”.

Further, upon receiving a take-off command, which is also an example of the control command, the drone 30 takes off and tracks a BWC position (that is, the police officer). As a result, the image and the sound around the police officer are recorded in the drone recorded data. Upon receiving a return command which is also an example of the control command, the drone 30 returns to a position of the ICV 20 (that is, a position of the patrol car) and lands.

Upon receiving a tracking command, which is also an example of the control command, the drone 30 tracks a target specified by the tracking command. The above control commands may be transmitted from the ICV 20 and/or the center server 40.

The drone 30 may transmit the drone recorded data to the ICV 20. That is, the drone recorded data may be managed by the ICV 20. The drone 30 may transmit the drone recorded data to the ICV 20 at any time during the recording. Alternatively, the drone 30 may transmit the drone recorded data to the ICV 20 after the recording is stopped or after the landing.

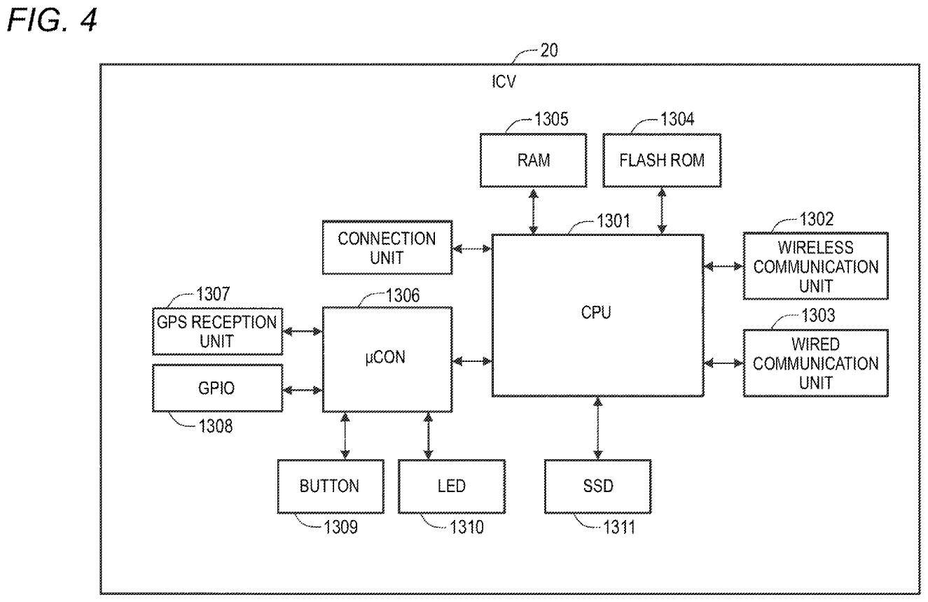

Next, a configuration of the ICV 20, which is an example of an in-vehicle recorder, will be described with reference to FIG. 4.

As shown in FIG. 4, the ICV 20 includes a CPU 1301, a wireless communication unit 1302, a wired communication unit 1303, a flash ROM 1304, a RAM 1305, a μCON 1306, a GPS reception unit 1307, a GPIO 1308, a button 1309, an LED 1310, and an SSD 1311.

The CPU 1301 performs, for example, a control process for controlling an overall operation of each unit of the ICV 20, a data input and output process with respect to other units, a data calculation process, and a data storage process.

The wireless communication unit 1302 performs wireless communication with an external device via a radio channel. The wireless communication includes, for example, wireless local area network (LAN) communication, near field communication (NFC), and Bluetooth (registered trademark). The wireless LAN communication is performed in accordance with, for example. IEEE 802.11n standard of Wi-Fi (registered trademark). The CPU 1301 and the wireless communication unit 1302 are connected to each other via, for example, a peripheral component interconnect (PCI) or a USB. The wireless communication unit 1302 performs wireless communication with, for example, the in-vehicle camera 22a, the PC 50, the BWC 10, the PC in the police station, and/or the center server 40.

The wired communication unit 1303 performs wired communication with an external device via a wired circuit (for example, a wired LAN). The wired communication unit 1303 performs wired communication with, for example, the in-vehicle camera 22a, the PC 50, the BWC 10, the PC in the police station, and/or the center server 40.

The flash ROM 1304 is, for example, a memory that stores a program and data used for controlling the CPU 1301. Various types of setting information are also held therein.

The RAM 1305 is, for example, a work memory used during an operation of the CPU 1301. For example, a plurality of the RAMS 1305 are provided.

The μCON 1306 is, for example, a type of microcomputer, which is connected to units related to an external interface (for example, the GPS reception unit 1307, the GPIO 1308, the button 1309, and the LED 1310), and performs control related to the external interface. The μCON 1306 is connected to the CPU 1301 via, for example, a universal asynchronous receiver transmitter (UART).

For example, the GPS reception unit 1307 receives, from a GPS transmitter (not shown), current position information of the ICV 20 and time information, and then outputs the received information to the CPU 1301. The time information is used to correct a system time of the ICV 20.

The GPIO 1308 is, for example, a parallel interface, which inputs and outputs a signal between an external device (not shown) connected via the GPIO 1308 and the μCON 1306. For example, various sensors (for example, a speed sensor, an acceleration sensor, and a door opening and closing sensor) are connected to the GPIO 1308.

The button 1309 includes, for example, a recording button used for starting or stopping recording of image data captured by the in-vehicle camera 22a, and an addition button used for adding attribute information or meta information to the image data captured by the in-vehicle camera 22a.

For example, the LED 1310 displays, by lighting, extinguishing, blinking, or the like, a power supply state (on/off state) of the ICV 20, an execution state of the recording, a state of connection of the ICV 20 to the LAN, and a use state of the LAN connected to the ICV 20.

The SSD 1311, which is an example of a storage, stores, for example, data (hereinafter, referred to as “ICV recorded data”) of the image captured by the in-vehicle camera 22a and a sound collected by a microphone. In the ICV recorded data, images and sounds around the patrol car (the site, the target and/or the police officer) are recorded. The SSD 1311 stores the SWC recorded data transmitted from the BWC 10. The SSD 1311 also stores the drone recorded data transmitted from the drone 30. The SSD 1311 may also store data other than image data. The SSD 1311 is connected to the CPU 1301 via serial ATA (SATA). A plurality of the SSDs 1311 may be provided. A storage (for example, an HDD) other than the SSD 1311 may also be provided.

The ICV 20 receives input of event information through the PC 50 connected to the ICV 20. For example, after processing the event, the police officer operates the PC 50 so as to input event information related to the event, and associates the event information with the BWC recorded data, the ICV recorded data, and the drone recorded data in which a site of the event is recorded. The event information includes, for example, information on the event, such as a name and/or an address of an investigation target who is a suspect of a crime, an accident, or a traffic violation, and information such as a signature of the investigation target. The PC 50 is an example of an input terminal, and the PC 50 may also be replaced with a smartphone, a tablet terminal, or the like.

The ICV 20 may associate (set) the event information with the BWC recorded data, the ICV recorded data, and the drone recorded data in which the site of the event is recorded, and transmit the associated information to the center server 40. As a result, the center server 40 can manage the event information, the BWC recorded data, the ICV recorded data, and the drone recorded data related to the event at the site in association with each other.

The center server 40 manages the event information and the recorded data collected from each ICV 20. The center server 40 may also be capable of issuing an instruction to each ICV 20 and/or each drone 30.

It should be noted that the configuration shown in FIG. 1 is an example and the security system 1 may have a configuration different from that shown in FIG. 1. For example, in the present disclosure, a part of processing performed by the ICV 20 (for example, processing related to control of the drone 30) may also be performed by another device (for example, a drone control device). The drone 30 may also be provided in a vehicle other than the patrol car including the ICV 20. The drone 30 may also be fixedly set in a predetermined place (for example, a police station or a police box).

<Drone Take-Off>

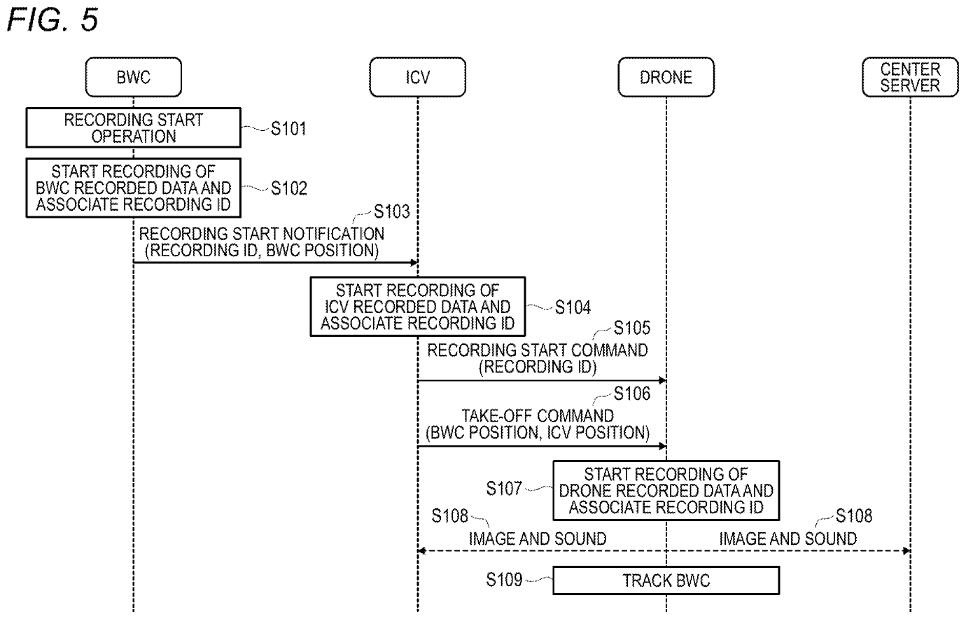

Next, an example of a take-off process of the drone 30 will be described with reference to a sequence chart shown in FIG. 5.

When the police officer performs a recording start operation of the BWC 10 (S101), the BWC 10 starts the recording of the BWC recorded data and associates a recording ID with the BWC recorded data (S102). The recording ID is an identifier used for associating the BWC recorded data, the ICV recorded data, the drone recorded data, and the event information with each other. The recording ID may be any information that can be uniquely identified, such as date and time when the recording start operation of 5101 is performed.

Next, the BWC 10 transmits a recording start notification including BWC position information and the recording ID to the ICV 20 (S103).

Upon receiving the recording start notification of S103, the ICV 20 starts the recording of the ICV recorded data and associates the recording ID included in the recording start notification with the ICV recorded data (S104).

Then the ICV 20 transmits the recording start command including the recording ID to the drone 30 (S105). Next, the ICV 20 transmits a take-off command including the BWC position information and information indicating the current position of the ICV 20 (hereinafter referred to as the “ICV position information”) to the drone 30 (S106). Here, by transmitting the recording start command first and transmitting the take-off command later, a possibility that the drone 30 cannot receive the recording start command after the take-off is reduced. It should be noted that the ICV 20 may also transmit the recording start command and the take-off command as one single command.

Upon receiving the recording start command of S105, the drone 30 starts the recording of the drone recorded data and associates the recording ID included in the recording start command with the drone recorded data (S107). Then the drone 30 stream-transmits the image and the sound to the center server 40 and the ICV 20 (S108). The drone 30 may perform the stream transmission of the image and the sound from the reception of the recording start command to reception of a recording stop command to be described later below.

Upon receiving the take-off command of S106, the drone 30 takes off and tracks a position indicated by the BWC position information included in the take-off command (S109). The BWC 10 may transmit the BWC position information to the drone 30 at any time via the ICV 20 so as to be capable of moving the drone 30 to track the BWC 10.

As described above, the drone 30 tracks the BWC 10 while recording the drone recorded data with the start of the recording of the BWC 10 serving as a trigger. As a result, the image and the sound of the site can be recorded from the drone 30 without requiring the police officer at the site to perform any complicated operation.

In S109, after arriving at the position indicated by the BWC position information, the drone 30 may recognize a face image of the police officer wearing the BWC 10 and track the police officer.

In a case where the drone 30 is provided at a place other than the patrol car, in S109, the drone 30 may track a position indicated by the ICV position information included in the take-off command of S106. In this case, after arriving at the position indicated by the ICV position information, the drone 30 may recognize a number plate of the patrol car including the ICV 20 and track the number plate.

<Modification of Drone Take-Off>

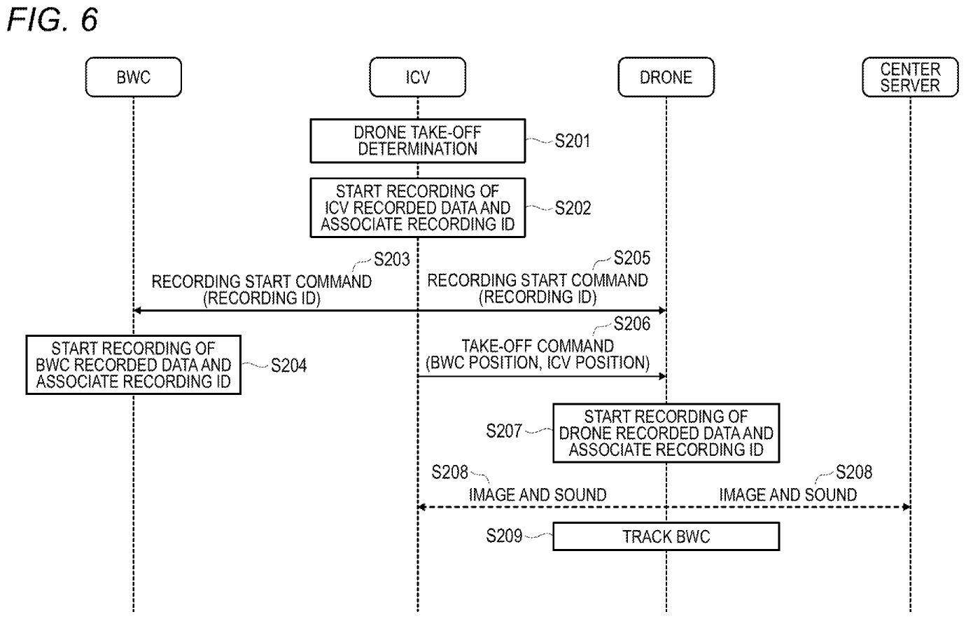

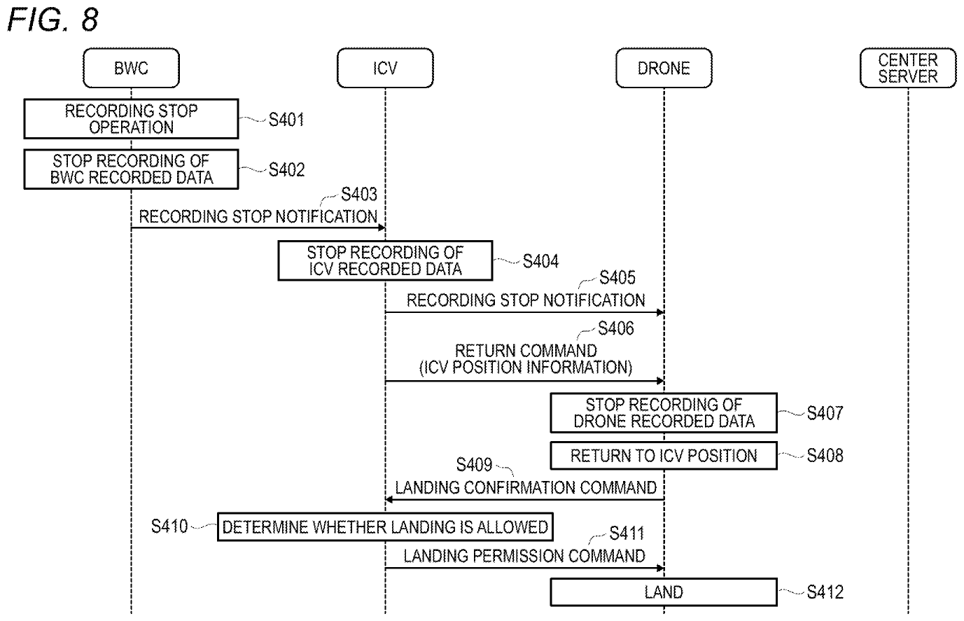

Next, a modification of the sequence chart shown in FIG. 5 will be described with reference to a sequence chart shown in FIG. 6. In FIG. 5, the drone 30 starts the take-off and the recording triggered by the recording start operation of the BWC 10. On the other hand, the ICV 20 determines the start of the take-off and the recording of the drone 30 in FIG. 8.

The ICV 20 determines whether a take-off condition of the drone 30 is satisfied (S201). A case where the take-off condition of the drone 30 is satisfied refers to, for example, (A1) a case where a warning lamp of the patrol car including the ICV 20 is turned on while the patrol car is stopped. This is because the turning on of the warning lamp of the patrol car means that an event has occurred, and the stopping of the patrol car means that the patrol car has arrived at the site of the event. Alternatively, the case where the take-off condition of the drone 30 is satisfied refers to a case where (A1) is satisfied while (A2) the BWC 10 is separated from the ICV 20 by a predetermined or more distance (that is, a case where the police officer gets off the patrol car). As a result, when the patrol car is stopped due to a traffic light, traffic congestion, or the like (that is, at a place other than the site), the drone 30 can be prevented from erroneously taking off.

Next, when it is determined in S201 that the take-off condition of the drone 30 is satisfied, the ICV 20 starts the recording of the ICV recorded data and associates the recording ID with the ICV recorded data (S202).

Next, the ICV 20 transmits the recording start command including the recording ID to the BWC 10 (S203). Upon receiving the recording start command of S203, the BWC 10 starts the recording of the BWC recorded data and associates the recording ID included in the recording start command with the BWC recorded data (S204).

The ICV 20 transmits the recording start command and the take-off command to the drone 30 in the same manner as 5105 and S106 of FIGS. 5 (S205 and S206). Subsequent processes of S207 to S209 is the same as the processes of S107 to S109 of FIG. 5, and description thereof will thus be omitted.

As described above, the drone 30 tracks the BWC 10 while recording the drone recorded data with the satisfaction of the take-off condition of the drone 30 in the ICV 20 serving as a trigger. As a result, the image and the sound of the site can be recorded from the drone 30 without requiring the police officer at the site to perform any complicated operation.

<Target Tracking>

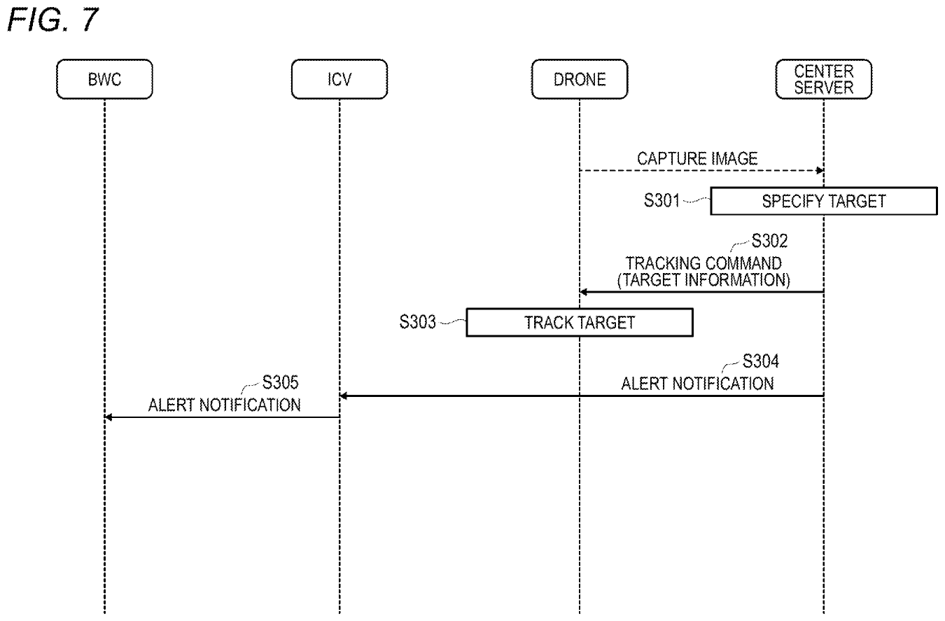

Next, an example of a process in which the drone 30 tracks a target will be described with reference to a sequence chart shown in FIG. 7. The process of FIG. 7 is a continuation of the processes shown in FIG. 5 or 6. However, the process of FIG. 7 may not be executed when the target does not need to be tracked.

The center server 40 specifies the target based on the image stream-transmitted from the drone 30 (S301). For example, an operator of the center server 40 visually observes the image from the drone 30 so as to specify the target. Alternatively, the center server 40 detects a face image, a number plate, or the like of the target registered in a black list in advance based on the image from the drone 30, and specifies the target.

When the target is specified, the center server 40 transmits a tracking command including target information to the drone 30 (S302). The target information includes information on the target specified in S301. For example, the target information includes coordinates of the specified target on the image. Alternatively, the target information includes the face image, the number plate, or the like of the specified target.

Upon receiving the tracking command of S302, the drone 30 uses the target information included in the tracking command to specify the target from the image being captured by the camera, and tracks the specified target (S303).

When the target is specified in S301, the center server 40 transmits an alert notification to the ICV 20 (S304). When the ICV 20 receives the alert notification of S304, the ICV 20 notifies the BWC 10 of the same alert notification (S305). As a result, the police officer can know that caution is needed since there is a target in the vicinity.

<Drone Landing>

Next, an example of a landing process of the drone 30 will be described with reference to a sequence chart shown in FIG. 8. The process of FIG. 8 is a continuation of the processes of any one of FIGS. 5, 6, and 7.

When the police officer performs a recording stop process operation of the BWC 10 (S401), the BWC 10 stops the recording of the BWC recorded data (S402). Then the BWC 10 transmits a recording stop notification to the ICV 20 (S403).

Upon receiving the recording stop notification of S403, the ICV 20 stops the recording of the ICV recorded data (S404). Next, the ICV 20 transmits the recording stop command to the drone 30 (S405). The ICV 20 also transmits a return command including the ICV position information to the drone 30 (S406). It should be noted that the ICV 20 may also transmit the recording stop command and the return command as one single command.

Upon receiving the recording stop command of S405, the drone 30 stops the recording of the drone recorded data (S407). Upon receiving the return command of S406, the drone 30 returns to the position indicated by the ICV position information included in the return command (that is, the position of the patrol car) (S408).

Upon arriving at the position indicated by the ICV position information (that is, above the patrol car), the drone 30 transmits a landing confirmation command to the ICV 20 (S409).

Upon receiving the landing confirmation command of S409, the ICV 20 determines whether the drone 30 can land (S410). For example, the ICV 20 determines that the landing is not allowed when the patrol car is traveling, and determines that the landing is allowed when the patrol car is stopped. The ICV 20 may also receive a predetermined signal from the patrol car and determine Whether the patrol car is traveling.

When it is determined that the landing is allowed in S410, the ICV 20 transmits a landing permission command to the drone 30 (S411). Upon receiving the landing permission command in S411, the drone 30 lands on the patrol car (S412).

As described above, the drone 30 stops the recording of the drone recorded data with the stop of the recording of the BWC 10 serving as a trigger, and returns to the position of the ICV 20 (the patrol car). The drone 30 automatically lands when the patrol car is laudable. As a result, after the processing of the event, the drone 30 can be collected without requiring the police officer at the site to perform any complicated operation.

It should be noted that although the ICV 20 determines whether the drone 30 can land in the example of FIG. 8, the drone 30 may also determine whether the landing is allowed. For example, the drone 30 may determine whether the patrol car, which is a destination of the landing, is traveling based on the image being captured by the camera, and automatically land when the patrol car is stopped.

<Recorded Data Management>

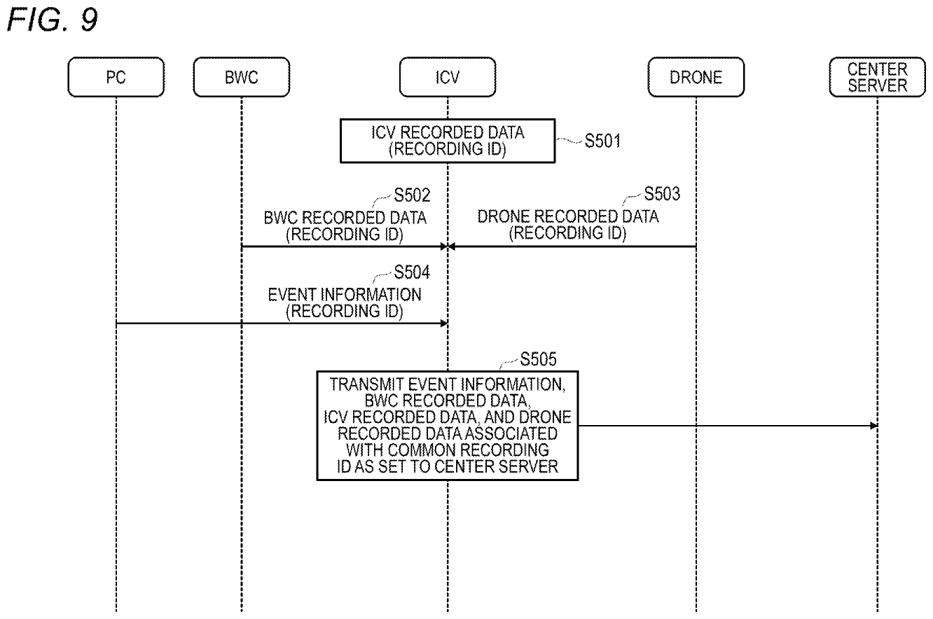

Next, an example of a process of associating the event information with the recorded data will be described with reference to a sequence chart shown in FIG. 9. The process of FIG. 9 is a continuation of the process of FIG. 8.

The ICV 20 stores the ICV recorded data associated with the recording ID in the storage (S501). The ICV 20 also acquires the BWC recorded data associated with the recording ID from the BWC 10 and stores the BWC recorded data in the storage (S502). The ICV 20 also acquires the drone recorded data associated with the recording ID from the drone 30 and stores the drone recorded data in the storage (S503).

The police officer operates the PC 50, inputs the event information to ICV 20, and associates the event information with the recording ID (S504).

The ICV 20 transmits the event information, the BWC recorded data, the ICV recorded data, and the drone recorded data associated with the common recording ID as a set to the center server 40 (S505).

As described above, the BWC recorded data, the ICV recorded data, and the drone recorded data in which the image and the sound of the common site and/or the target are recorded are associated with each other by the common recording ID. As a result, the police officer can easily associate the BWC recorded data, the ICV recorded data, and the drone recorded data, in which the site and/or the target indicated by the event information is recorded, with the input event information. The center server 40 can also use the recording ID as a key to manage and search for the event information, the BWC recorded data, the ICV recorded data, and the drone recorded data related to the common site and/or the target.

It should be noted that the association provided by the recording ID described above is not an essential configuration in the present embodiment. For example, in a case where the association of the event information, the BWC recorded data, the ICV recorded data, and the drone recorded data shown in FIG. 9 is not implemented, the above-described recording ID may be omitted.

### Embodiment 2

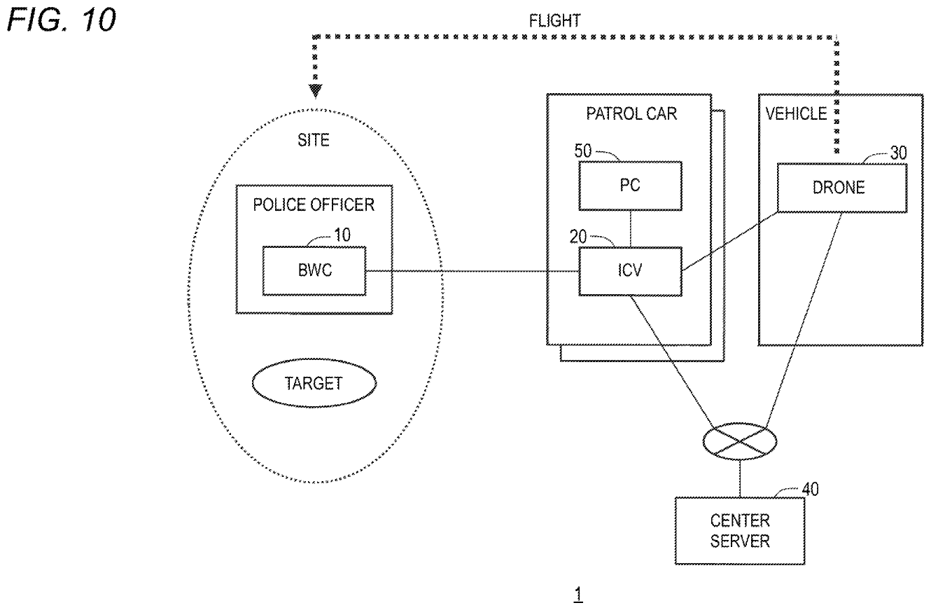

FIGS. 10 shows a configuration example of the security system 1 according to Embodiment 2. In FIG. 10, the drone 30 is provided in a vehicle other than a plurality of patrol cars including ICVs 20. Description of the contents already described in Embodiment 1 may be omitted in Embodiment 2.

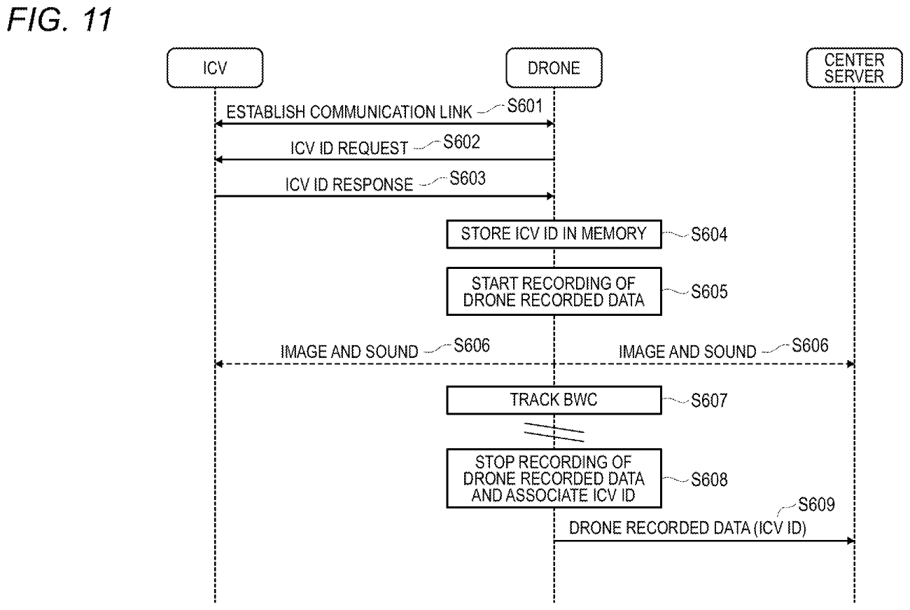

Next, an example of a process according to Embodiment 2 will be described with reference to a sequence chart shown in FIG. 11.

The drone 30 establishes a communication link with one of the plurality of ICVs 20 (S601). For example, the ICV 20 that has detected occurrence of an event establishes the communication link with one drone 30.

The drone 30 which has established the communication link transmits an ICV ID request to the ICV 20 (S602), and receives an ICV ID response from the ICV 20 (S603). The ICV ID is information for identifying the ICV 20. Instead of the ICV ID, information for identifying a patrol car including the ICV 20 (for example, a vehicle ID) may also be used.

The drone 30 stores the ICV ID of S603 in the memory (S604). As a result, the ICV ID of the ICV 20 with which the communication link is established is stored in the memory of the drone 30.

In the same manner as S107 to S109 shown in FIG. 5, the drone 30 starts the recording the drone recorded data (S605), stream-transmits the image and the sound (S606), and tracks the BWC 10 (S607). It should be noted that the recording ID may not be associated in S605, which is different from S107.

When the recording of the drone recorded data is stopped, the drone 30 associates the ICV ID stored in the memory with the drone recorded data (S608). The drone 30 may perform at least a part of the processes shown in FIG. 7 and/or FIG. 8 until the drone recorded data is stopped.

Then the drone 30 transmits the drone recorded data associated with the ICV ID to the center server 40 (S609).

According to the above process, the center server 40 can identify which IC′F 20 has issued an instruction to record the drone recorded data with reference to the ICV ID. The center server 40 receives, from the ICV 20, the event information, the BWC recorded data, and the ICV recorded data associated with the ICV ID instead of the recording ID described in Embodiment 1, and can thus use the common ICV ID as the key to manage and search for the event information, the BWC recorded data, the ICV recorded data, and the drone recorded data related to the common site and/or the target.

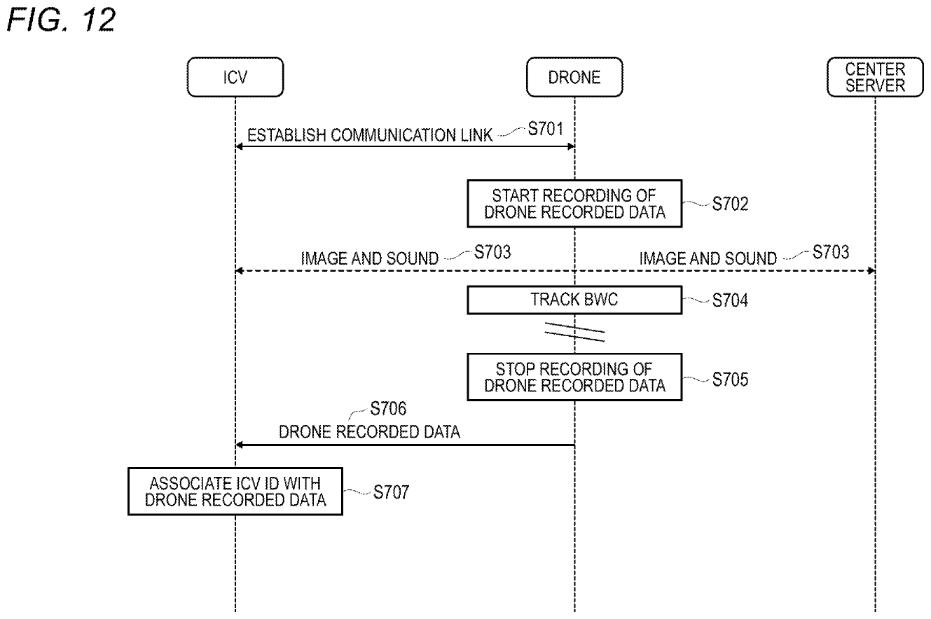

Next, a modification of the sequence chart shown in FIG. 11 will be described with reference to a sequence chart shown in FIG. 12.

In the same manner as S601 of FIG. 11, the drone 30 establishes the communication link with one of the plurality of ICVs 20 (S701). Then the drone 30 performs the same processes as S605 to S607 shown in FIGS. 11 (S702 to S704). That is, the drone 30 does not need to store the ICV ID in the memory, which is different from the case shown in FIG. 11.

When the recording of the drone recorded data is stopped (S705), the drone 30 transmits the drone recorded data to the ICV 20 (S706).

Upon receiving the drone recorded data of S706, the ICV 20 associates the ICV ID of the ICV 20 with the drone recorded data (S707).

By the above process, the same effect as in the case of FIG. 11 can still be achieved.

### Embodiment 3

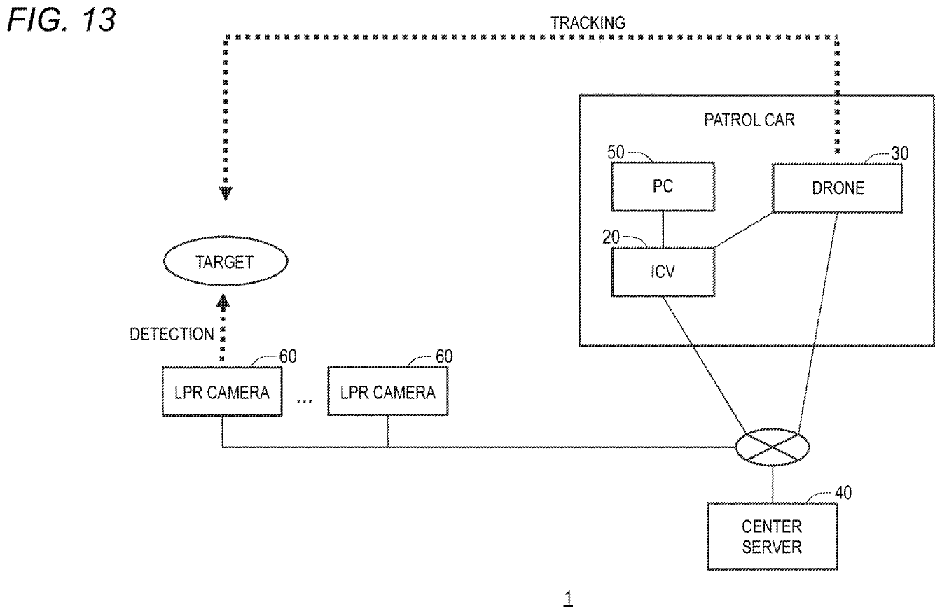

FIG. 13 shows a configuration example of the security system 1 according to Embodiment 3. In FIG. 13, a plurality of license plate recognition (LPR) cameras 60 are added to the configuration of FIG. 1. Description of the contents already described in Embodiment 1 may be omitted in Embodiment 3.

The LPR camera 60 is an example of a surveillance camera, and is provided on a road or the like. The LPR camera 60 can detect a number plate of a vehicle by image processing or the like. The LPR camera 60 may transmit and receive data to and from the ICV 20, the drone 30, and/or the center server 40.

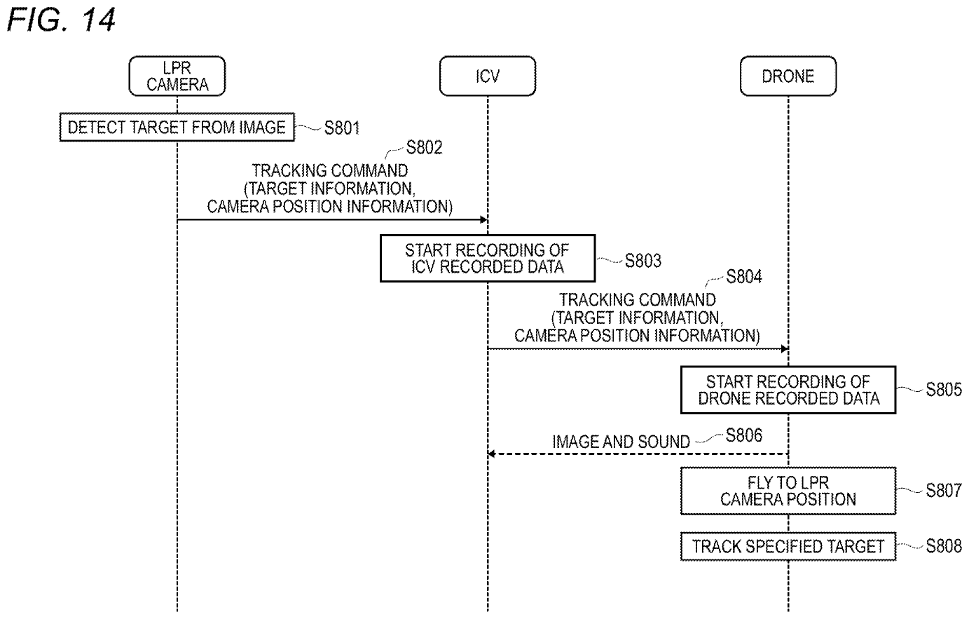

Next, an example of a process of the security system 1 shown in FIG. 13 will be described with reference to a sequence chart shown in FIG. 14.

When the LPR camera 60 detects a number plate of a target (vehicle) based on a captured image (S801), the LPR camera 60 transmits a tracking command including target information of the target (the number plate in this case) and information indicating a position of the LPR camera 60 (hereinafter referred to as the “position information of the LPR camera 60”) to the ICV 20 (S802).

When the ICV 20 receives the tracking command of 5802, the ICV 20 starts the recording of the ICV recorded data (S803). The ICV 20 also transmits a tracking command similar to that in 5802 to the drone 30 (S804).

Upon receiving the tracking command of S804, the drone 30 starts the recording of the drone recorded data (S805). The drone 30 also stream-transmits the image and the sound to the ICV 20 (and the center server 40) (S806).

Then the drone 30 flies toward the position indicated by the position information of the LPR camera 60 included in the tracking command of S804 (S807). When the target is moving, the target may be detected by another LPR camera 60 while the drone 30 is flying. in this case, the drone 30 may fly toward a position of the LPR camera 60 that detects the target at last.

When the drone 30 specifies the number plate indicated by the target information based on the image after arriving at the position indicated by the LPR position information, the drone 30 tracks the specified target (S808).

As described above, the drone 30 tracks the target while recording the drone recorded data with the detection of the target performed by the LPR camera 60 serving as a trigger. As a result, the image and the sound of the target can be recorded from the drone 30 without performing any complicated operation.

Although the LPR camera 60 detects the target in the process of FIG. 14, another device may also detect the target. For example, the LPR camera 60 may transmit the captured image to the center server 40, and the center server 40 may detect the target based on the received image. In this case, the center server 40 may transmit the tracking commands of S802 and S804 to the ICV 20 and the drone 30.

### Embodiment 4

Since a site of an event or an accident requires an urgent response, for example, it is not preferable that an operation of an unmanned aerial vehicle is complicated when a target such as a person or a vehicle that escapes from the site is tracked and recorded by the unmanned aerial vehicle. In Embodiment 4, the target can be tracked and imaged by the unmanned aerial vehicle with a simple operation.

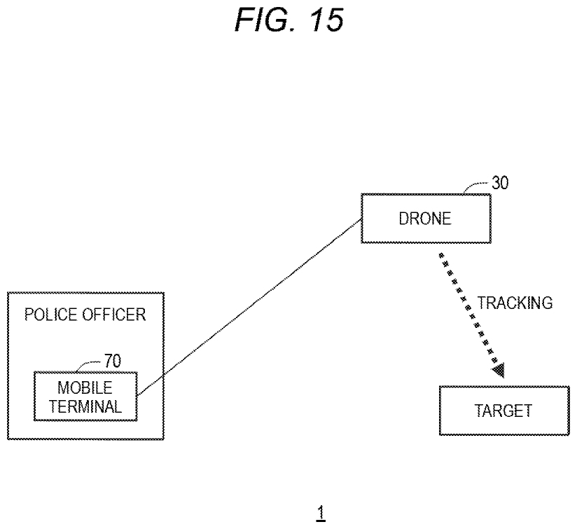

FIG. 15 shows a configuration example of the security system 1 according to Embodiment 4. The security system 1 shown in FIG. 15 includes the drone 30 and a mobile terminal 70 carried by the police officer.

The drone 30 has a patrol mode in which the drone 30 patrols a predetermined route, a manual mode in which the drone 30 operates in accordance with an operation from the mobile terminal 70, and a tracking mode in which the drone 30 tracks the target. However, the drone 30 does not necessarily have all of these modes, and may have at least one mode.

The mobile terminal 70 can transmit and receive data to and from the drone 30 via a communication network. The mobile terminal 70 may be, for example, a smartphone, a tablet terminal, the mobile PC 50, or the like. A UI (hereinafter, referred to as the “drone UI”) for operating the drone 30 is displayed on the mobile terminal 70.

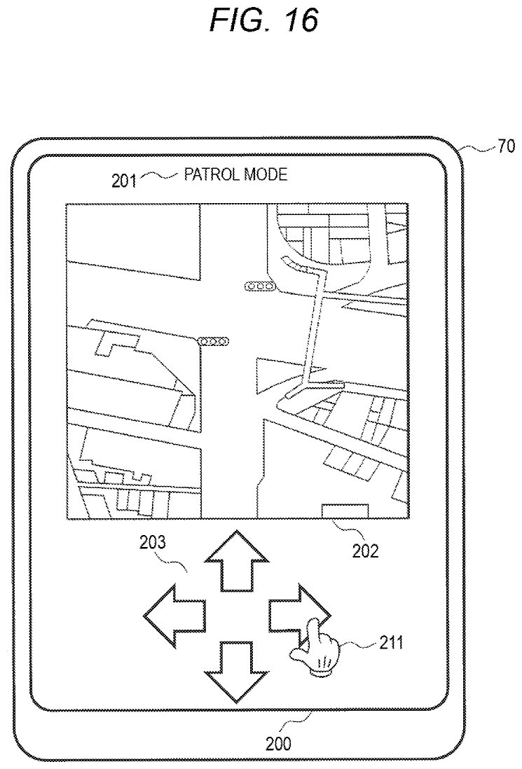

Next, an example of the drone UI will be described with reference to FIGS. 16, 17, and 18.

As shown in FIGS. 16 to 18, a drone UI 200 includes a mode display region 201, an image display region 202, and an operation button 203.

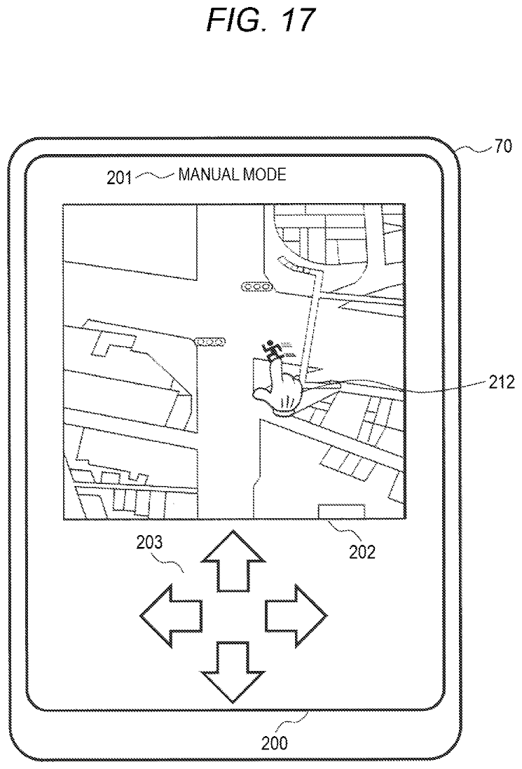

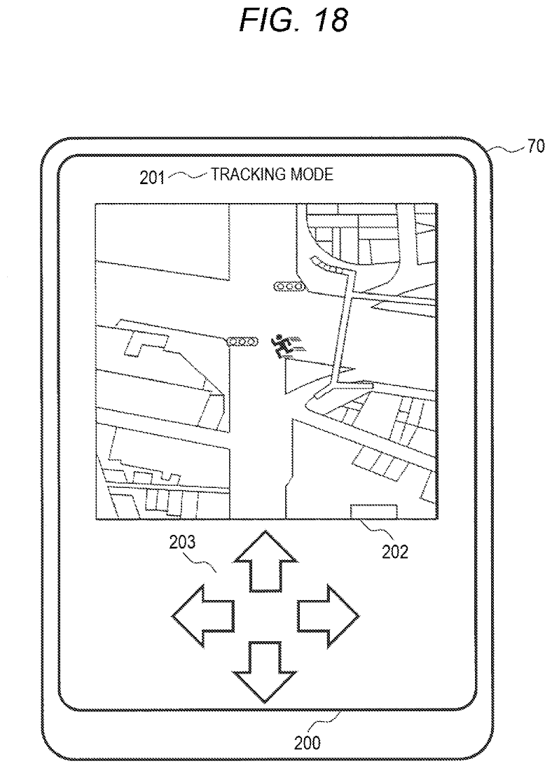

In the mode display region 201, which mode the drone 30 is in is displayed. FIG. 16 is a display example where the drone 30 is in the patrol mode, FIG. 17 is a display example where the drone 30 is in the manual mode, and FIG. 18 is a display example where the drone 30 is in the tracking mode. In the image display region 202, an image which is captured by the camera 1203 of the drone 30 and stream-transmitted from the drone 30 is displayed. The operation button 203 is a button for operating the drone 30.

In the patrol mode or the tracking mode, when the operation button 203 is operated (for example, an operation of a finger 211 shown in FIG. 16), the drone 30 may be switched to the manual mode. In the patrol mode or the manual mode, when an operation of specify the target is performed on the image display region 202 (for example, an operation of a finger 212 shown in FIG. 17), the drone 30 may be switched to the tracking mode so as to track the target. In the manual mode, when the operation button 203 is not operated for a certain or longer period of time, the drone 30 may be switched to the patrol mode.

In the tracking mode, when an operation of specifying another target is performed on the image display region 202, the drone 30 may turn to the tracking mode of tracking the other target. When the drone 30 loses sight of the target in the tracking mode, the drone 30 may be switched to the manual mode or the patrol mode.

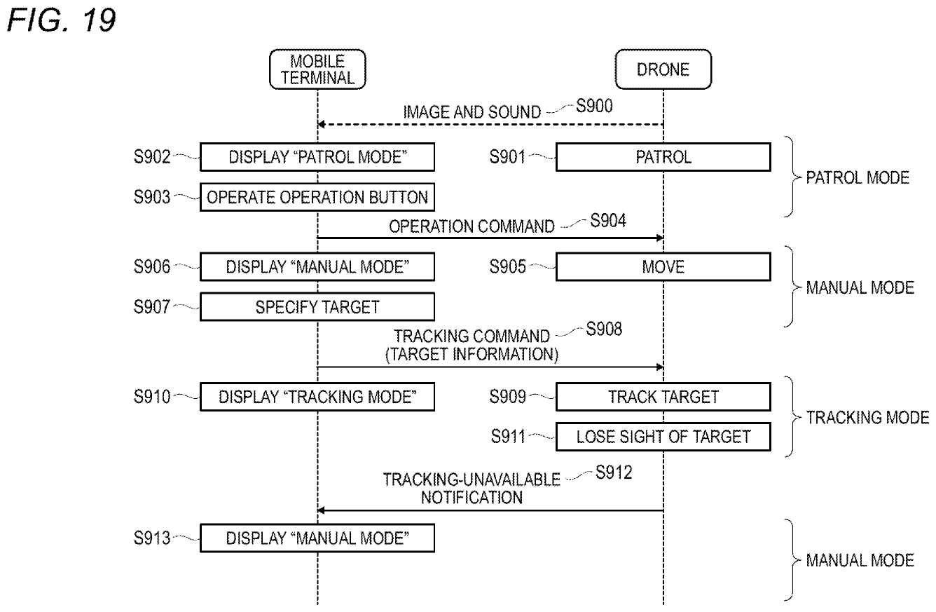

Next, an example of a process of the security system 1 shown in FIG. 15 will be described with reference to a sequence chart shown in FIG. 19.

The drone 30 stream-transmits the image and the sound to the mobile terminal 70 (S900). The mobile terminal 70 receives the image and displays the image in the image display region 202 of the drone UI 200. The drone 30 may also stream-transmit the image to the mobile terminal 70 while the drone 30 is connected to the mobile terminal 70.

The drone 30 patrols the predetermined route in the patrol mode (S901). When the drone 30 is in the patrol mode, as shown in FIG. 16, the mobile terminal 70 displays “patrol mode” in the mode display region 201 of the drone UI 200 (S902).

As shown in FIG. 16, when the police officer operates the operation button 203 of the drone UI 200 (S903), the mobile terminal 70 transmits an operation command including operation contents to the drone 30 (S904).

Upon receiving the operation command of S904, the drone 30 is switched to the manual mode and moved in accordance with the operation command (S905). When the drone 30 is in the manual mode, as shown in FIG. 17, the mobile terminal 70 displays “manual mode” in the mode display region 201 of the drone UI 200 (S906).

As shown in FIG. 17, when the police officer performs an operation of specifying the target on the image display region 202 of the drone UI 200 (S907), the mobile terminal 70 transmits the tracking command including the target information related to the specified target to the drone 30 (S908). The target information may include coordinates of the specified target in the image display region 202. Alternatively, the target information may include features (color, shape, and the like) of the image of the specified target.

Upon receiving the tracking command of S908, the drone 30 switches to the tracking mode. Then the drone 30 uses the target information included in the tracking command to specify the target from the image being captured, and tracks the specified target (S909). When the drone 30 is in the tracking mode, as shown in FIG. 18, the mobile terminal 70 displays “tracking mode” in the mode display region 201 of the drone 1 TI 200 (S910). The drone 30 may also uses the reception of the tracking command as a trigger to start the recording of the drone recorded data.

When the drone 30 loses sight of the target specified from the image being captured (S911), for example, when the target moves out of the image being captured or enters a building, the drone 30 transmits a tracking-unavailable notification to the mobile terminal 70 (S912) and switches to the manual mode.

Upon receiving the tracking-unavailable notification of S912, the mobile terminal 70 displays the “manual mode” in the mode display region 201 of the drone UI 200 (S913).

As described above, the operation of the drone 30 is switched to the patrol mode, the manual mode, or the tracking mode in accordance with the operation from the mobile terminal 70. As a result, the police officer can appropriately switch the mode of the drone 30 and thus use the drone 30 to easily perform monitoring, tracking, and the like of the target. Moreover, a current mode of the drone 30 is displayed on the drone UI 200 of the mobile terminal 70. As a result, the police officer can know which mode the drone 30 is currently in.

### Embodiment 5

Since an unmanned aerial vehicle such as a drone is powered by a battery, a flight distance thereof is limited. Therefore, as a tracking system using an unmanned aerial vehicle, a tracking system capable of tracking a tracking target such as a suspect over a long distance is desired. In Embodiment 5, the tracking target can be tracked over a long distance.

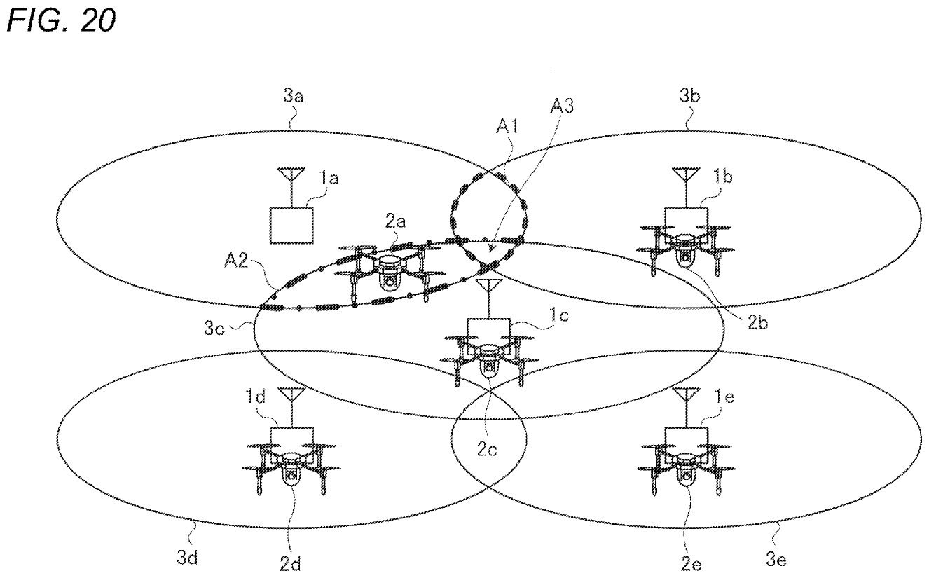

FIG. 20 shows a configuration example of a tracking system according to Embodiment 5. As shown in FIG. 20, the tracking system includes base stations 1a to 1e and unmanned aerial vehicles 2a to 2e.

The unmanned aerial vehicles 2a to 2e are, for example, drones on which cameras are mounted. The unmanned aerial vehicles 2a to 2e fly by batteries and autonomously track a tracking target such as a suspect or a vehicle driven by the suspect. For example, the unmanned aerial vehicles 2a to 2e determine the tracking target to be tracked based on an image captured by a camera, and autonomously track the tracking target such as the suspect. The unmanned aerial vehicles 2a to 2e may switch from autonomous flight to manual flight operated by a user when the user operates a remote operation device during the autonomous. flight.

The base stations 1a to 1e are provided, for example, each on a roof of a police station in each place. Each of the unmanned aerial vehicles 2a to 2e belongs to each of the base stations 1a to 1e. and performs wireless communication with the base stations 1a to 1e. For example, the base station 1a performs wireless communication with the unmanned aerial vehicle 2a. The base station 1b performs wireless communication with the unmanned aerial vehicle 2b. Similarly, each of the base stations 1c to 1e performs wireless communication with each of the unmanned aerial vehicles 2c to 2e.

The base stations 1a to 1e each form a communication area in which the wireless communication with the unmanned aerial vehicles 2a to 2e is performed. During the flight, each of the unmanned aerial vehicles 2a to 2c flies in the communication area of each of the base stations 1a to 1e such that the unmanned aerial vehicles 2a to 2e can wirelessly communicate with the base stations 1a to 1e. For example, a zone 3a shown in FIG. 20 indicates a flight range of the unmanned aerial vehicle 2a. For example, the zone 3a may have the same shape as the communication area formed by the base station 1a, or may be smaller than the communication area formed by the base station 1a.

In the same way, each of zones 3b to 3e indicates a flight range of each of the unmanned aerial vehicles 2b to 2e. Each of the zones 3b to 3e may have, for example, the same shape as the communication area formed by each of the base stations 1b to 1e, or may be smaller than the communication area formed by each of the base stations 1b to 1e.

The zones 3a to 3e are set to partially overlap the adjacent zones 3a to 3e. In other words, the communication area is formed to partially overlap an adjacent communication area. For example, the zone 3a overlaps the zone 3b within a dotted line A1. The zone 3a overlaps the zone 3c within a one-dot chain line A2. Hereinafter, an area in which the zones 3a to 3e partially overlap each other may be referred to as an end of the zone. For example, regions of the zone 3a indicated by the dotted line A1 and the one-dot chain line A2 may be referred to as ends of the zone 3a.

The unmanned aerial vehicles 2a to 2e are each equipped with a global positioning system (GPS). The unmanned aerial vehicles 2a to 2c determine whether the unmanned aerial vehicles 2a to 2e are flying at ends of the zones 3a to 3e based on position information. provided by the GPS.

When the unmanned aerial vehicles 2a to 2e do not fly, the unmanned aerial vehicles 2a to 2e stand by in standby places. Each standby place is provided in the vicinity of each of the base stations 1a to 1e, and is provided on a roof of a police station or the like, for example. In the standby place, for example, a charging stand that charges a battery of each of the unmanned aerial vehicles 2a to 2e is provided. When each of the unmanned aerial vehicles 2a to 2e stands by, the battery thereof is charged by the charging stand.

The base stations 1a to 1e are connected to each other in a wired or wireless manner. For example, the base stations 1a to 1e are connected to each other by a network such as a local area network (LAN) or the Internet.

Here, since the unmanned aerial vehicles 2a to 2c fly by the batteries, the unmanned. aerial vehicles 2a to 2e may be difficult to track a tracking target which moves over a long distance. Therefore, in the tracking system shown in FIG. 20, the flight ranges of the unmanned aerial vehicles 2a to 2e are determined in advance. For example, as described above, each of the unmanned aerial vehicles 2a to 2e flies in each of the zones 3a to 3e.

In a case where the tracking target moves over a long distance, the unmanned aerial vehicles 2a to 2c track the tracking target in a relay manner. For example, the tracking target moves from the zone 3a to the zone 3c, and further moves from the zone 3c to the zone 3e. In this case, the unmanned aerial vehicle 2a flying in the zone 3a tracks the tracking target moving in the zone 3a. When the tracking target moves from the zone 3a to the zone 3c, the unmanned aerial vehicle 2c flying in the zone 3c tracks the tracking target moving in the zone 3c. When the tracking target moves from the zone 3c to the zone 3e, the unmanned aerial vehicle 2e flying in the zone 3e tracks the tracking target moving in the zone 3e. In this manner, the tracking system shown in FIG. 20 tracks the tracking target which moves over the long distance.

A schematic operation example of the tracking system shown in FIG. 20 will be described. The unmanned aerial vehicle 2a autonomously flies in the zone 3a, which is the flight range of the unmanned aerial vehicle 2a, and tracks the tracking target. The unmanned aerial vehicles 2b to 2e stand by in each standby place.

The unmanned aerial vehicle 2a sequentially acquires position information of the unmanned aerial vehicle 2a by the GPS, and determines whether the unmanned aerial vehicle 2a is flying at the end of the zone 3a. When the unmanned aerial vehicle 2a flies at the end of the zone 3a, the unmanned aerial vehicle 2a transmits a tracking takeover request of the tracking target to the base station 1a. At this time, the unmanned aerial vehicle 2a also transmits the current position information to the base station 1a.

Upon receiving the takeover request from the unmanned aerial vehicle 2a, the base station 1a determines (estimates) a zone (communication area) to which the tracking target is about to move based on the position information received from the unmanned aerial vehicle 2a.

For example, the unmanned aerial vehicle 2a flies at the end of the zone 3a indicated by the one-dot chain line A2. In this case, the tracking target is likely to move to the zone 3c which partially overlaps the zone 3a (the end of the zone 3a indicated by the one-dot chain line A2 is also the end of the zone 3c, and thus the tracking target can be regarded as moving to the zone 3c). Therefore, the base station 1a determines that the zone 3c (the communication area of the base station 1c) is a movement destination zone of the tracking target. When the unmanned aerial vehicle 2a is flying at the end of the zone 3a indicated by the dotted line A1, the tracking target is likely to move to the zone 3b which partially overlaps the zone 3a (the end of the zone 3a indicated by the dotted line A1 is also the end of the zone 3b, and thus the tracking target can be regarded as moving to the zone 3b). Therefore, in this case, the base station 1a determines that the zone 3b is the movement destination zone of the tracking target.

Upon determining that the zone Sc is the movement destination zone of the tracking target, the base station 1a transmits the tracking takeover request of the tracking target to the base station 1c which sets the determined zone 3e. At this time, the base station 1a also transmits the position information of the unmanned aerial vehicle 2a to the base station 1c.

Upon receiving the takeover request from the base station 1a, the base station 1c transmits a tracking start instruction to the unmanned aerial vehicle 2c flying in the zone 3c so as to start the tracking of the tracking target. At this time, the base station 1c also transmits the position information of the unmanned aerial vehicle 2a received from the base station 1a to the unmanned aerial vehicle 2c.

Upon receiving the tracking start instruction from the base station 1c, the unmanned aerial vehicle 2c flies to a position indicated by the position information received from the base station 1e. That is, the unmanned aerial vehicle 2c flies to a place where the unmanned aerial vehicle 2a is flying. Upon arriving at the position indicated by the position information, the unmanned aerial vehicle 2c starts the tracking of the tracking target in place of the unmanned aerial vehicle 2a. The unmanned aerial vehicle 2a that has finished tracking returns to the standby place of the unmanned aerial vehicle 2a.

As described above, the unmanned aerial vehicles 2a to 2e fly in the zones 3a to 3e (in the communication areas of the base stations 1a to 1e) and track the tracking target which moves across the zones 3a to 3e in the relay manner. As a result, the tracking system shown in FIG. 20 can track the tracking target over the long distance.

Although one of the unmanned aerial vehicles 2a to 2e belongs to each of the zones 3a to 3e in FIG. 20, the present invention is not limited thereto. A plurality of unmanned aerial vehicles may belong to each of the zones 3a to 3e.

The base stations 1a to 1e may be connected to an information processing device of a police center or a mobile terminal carried by a police officer. The base stations 1a to 1e may receive images captured by cameras of the unmanned aerial vehicles 2a to 2e and transmit the images to the information processing device of the police center or the mobile terminal carried by the police officer.

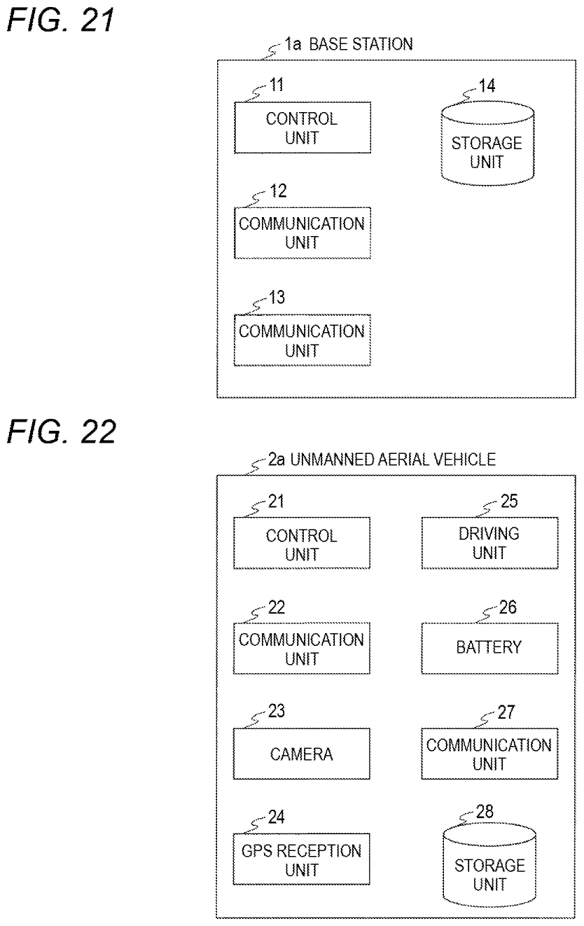

FIG. 21 shows a block configuration example of the base station 1a. As shown in FIG. 21, the base station 1a includes a control unit 11, communication units 12 and 13, and a storage unit 14.

The control unit 11 controls the entire base station 1a. The control unit 11 may be configured by, for example, a central processing unit (CPU).

The communication unit 12 performs wireless communication with the unmanned aerial vehicle 2a. The communication unit 13 communicates with the other base stations 1b to 1e.

The storage unit 14 stores a program for operating the control unit 11. Data for the control unit 11 to perform calculation processing, or data for the control unit 11 to control each unit is stored in the storage unit 14. The storage unit 14 may be configured by a storage device such as a RAM, a ROM, a flash memory, or an HDD.

The block configuration example of the base station 1a has been described in FIG. 21 and the base stations 1b to 1e also have the same blocks as those of the base station 1a. Each of the base stations 1a to 1e has the same function.

FIG. 22 shows a block configuration example of the unmanned aerial vehicle 2a. As shown in FIG. 22, the unmanned aerial vehicle 2a includes a control unit 21, a communication unit 22, a camera 23, a GPS reception unit 24, a driving unit 25, a battery 26, a communication unit 27, and a storage unit 28.

The control unit 21 controls the entire unmanned aerial vehicle 2a. The control unit 21 may be configured by, for example, a CPU.

The communication unit 22 performs wireless communication with the base station 1a. The camera 23 includes an optical lens, a lens control mechanism, an image sensor, and the like. The camera 23 outputs image data of a captured image to the control unit 21.

The GPS reception unit 24 receives GPS signals transmitted from a plurality of GPS satellites, and uses the received GPS signals to calculate the current position of the unmanned aerial vehicle 2a. The current position includes, for example, a latitude and a longitude.

The driving unit 25 is, for example, a motor, which rotates a propeller (not shown) of the unmanned aerial vehicle 2a under control of the control unit 21. The battery 26 is a power supply of the unmanned aerial vehicle 2a, and is, for example, a rechargeable secondary battery. The communication unit 27 performs direct wireless communication with the other unmanned aerial vehicles 2b to 2e without going through the base station 1a.

The storage unit 28 stores a program for operating the control unit 21. Data for the control unit 21 to perform calculation processing, or data for the control unit 21 to control each unit is stored in the storage unit 28. The storage unit 28 may be configured by a storage device such as a RAM, a ROM, a flash memory, or an HDD.

In FIG. 22, the block configuration example of the unmanned aerial vehicle 2a has been described, and the unmanned aerial vehicles 2b to 2e also have the same blocks as those of the unmanned aerial vehicle 2a. Each of the unmanned aerial vehicles 2a to 2e has the same function.

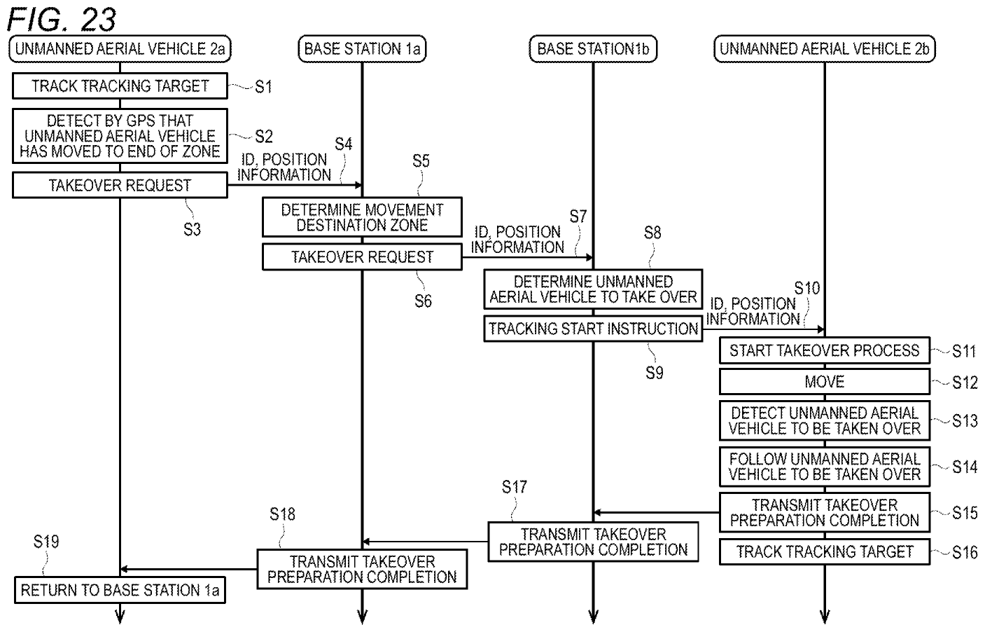

FIG. 23 is a sequence chart showing an operation example of the tracking system. Hereinafter, the tracking target moves from the zone 3a to the zone 3b. The unmanned aerial vehicles 2b to 2e stand by in each standby place.

The control unit 21 of the unmanned aerial vehicle 2a controls the driving unit such that the unmanned aerial vehicle 2a tracks the moving tracking target (step SI). Here, the operation example will be described until the unmanned aerial vehicle 2a starts the tracking of the tracking target. First, the control unit 21 of the unmanned aerial vehicle 2a transmits an image captured by the camera 23 to the information processing device of the police center via the base station 1a.

The police center selects the tracking target to be tracked from the image captured by the camera 23. For example, the police center clicks or taps the tracking target to be tracked on a display of the information processing device on which the image of the camera 23 is displayed so as to select the tracking target to be tracked. The information processing device transmits tracking information of the selected tracking target (for example, feature amounts such as a shape, a size, a color, and a pattern, and coordinates of the tracking target on a screen) to the unmanned aerial vehicle 2a via the base station 1a.

The control unit 21 of the unmanned aerial vehicle 2a controls the driving unit 25 based on the tracking information of the tracking target transmitted from the information processing device and the image captured by the camera 23, and autonomously tracks the tracking target. For example, the control unit 21 controls the driving unit 25 in such a manner that the tracking information is included in the image data of the image captured by the camera 23, and autonomously tracks the tracking target. In this manner, the unmanned aerial vehicle 2a starts the tracking of the moving tracking target.

The control unit 21 may also transmit the image captured by the camera 23 to the mobile terminal carried by the police officer. Then the police officer who carries the mobile terminal may use the mobile terminal to select the tracking target to be tracked.

The control unit 21 of the unmanned aerial vehicle 2a detects that the unmanned aerial vehicle 2a has moved to the end of the zone 3a (step S2). For example, the storage unit 28 of the unmanned aerial vehicle 2a stores map information of the zone 3a which includes information (latitude and longitude) of the end of the zone 3a. The GPS reception unit 24 sequentially acquires the position information of the unmanned aerial vehicle 2a. The control unit 21 detects that the unmanned aerial vehicle 2a has moved to the end of the zone 3a based on the position information of the unmanned aerial vehicle 2a acquired by the GPS reception unit 24 and the map information of the zone 3a stored in the storage unit 28.

Upon detecting the fact that the unmanned aerial vehicle 2a has moved to the end of the zone 3a, the control unit 21 of the unmanned aerial vehicle 2a transmits the takeover request to the base station 1a via the communication unit 22 (step S3). When the takeover request is transmitted to the base station 1a, the control unit 21 transmits an ID (identifier) of the unmanned aerial vehicle 2a and the position information indicating a flight position of the unmanned aerial vehicle 2a to the base station 1a.

The control unit 11 of the base station 1a receives the takeover request, the ID of the unmanned aerial vehicle 2a, and the position information of the unmanned aerial vehicle 2a from the unmanned aerial vehicle 2a via the communication unit 12 (step S4).

Upon receiving the takeover request from the unmanned aerial vehicle 2a, the control unit 11 of the base station 1a determines the movement destination zone of the tracking target based on the position information of the unmanned aerial vehicle 2a received in step S4 (step S5). For example, the control unit 11 determines the movement destination zone of the tracking target based on whether the unmanned aerial vehicle 2a is located (flying) in the region where the zone 3a and the zone 3b overlap each other (the region indicated by the dotted line A1 of FIG. 20) or a region where the zone 3a and the zone 3c overlap each other (the region indicated by the one-dot chain line A2 of FIG. 20). More specifically, when the unmanned aerial vehicle 2a is located in the region where the zone 3a and the zone 3b overlap each other, the control unit 11 determines that the zone 3b is the movement destination zone of the tracking target. When the unmanned aerial vehicle 2a is located in the region where the zone 3a and the zone Sc overlap each other, the control unit 11 determines that the zone Sc is the movement destination zone of the tracking target. In this case, the unmanned aerial vehicle 2a flies in the region where the zone Sa and the zone 3b overlap each other (the region indicated by the dotted line A1 of FIG. 20), and thus the control unit 11 determines that the zone 3b is the movement destination zone of the tracking target.

When the movement destination zone of the tracking target is determined, the control unit 11 of the base station 1a transmits the takeover request to the base station 1b in the movement destination zone via the communication unit 12 (step S6). When the takeover request is transmitted to the base station 1b, the control unit 11 transmits the ID of the unmanned aerial vehicle 2a and the position information of the unmanned aerial vehicle 2a received in step S4 to the base station 1b.

The control unit of the base station 1b receives the takeover request, the ID of the unmanned aerial vehicle 2a, and the position information of the unmanned aerial vehicle 2a from the base station 1a via the communication unit (step S7).

Upon receiving the takeover request from the base station 1a, the control unit of the base station 1b determines an unmanned aerial vehicle to take over the tracking from among unmanned aerial vehicles standing by in the zone 3b (step S8). For example, the control unit of the base station 1b may determine an unmanned aerial vehicle standing by for a longest time (an unmanned aerial vehicle that has flown at an earliest time) as the unmanned aerial vehicle to take over the tracking. In this ease, the control unit of the base station 1b determines the unmanned aerial vehicle 2b as the unmanned aerial vehicle to take over the tracking.

When the unmanned aerial vehicle 2b is determined to take over the tracking, the control unit of the base station 1b transmits a tracking start instruction to the unmanned aerial vehicle 2b (step S9). When the tracking start instruction is transmitted to the unmanned aerial vehicle 2b, the control unit of the base station 1b transmits the ID of the unmanned aerial vehicle 2a and the position information of the unmanned aerial vehicle 2a received in step S7 to the unmanned aerial vehicle 2b.

The control unit of the unmanned aerial vehicle 2b receives the tracking start instruction, the ID of the unmanned aerial vehicle 2a, and the position information of the unmanned aerial vehicle 2a from the base station 1b via the communication unit (step S10).

Upon receiving the tracking start instruction from the base station 1b, the control unit of the unmanned aerial vehicle 2b starts a takeover process (step S11). For example, the control unit of the unmanned aerial vehicle 2b controls the driving unit to start, flight.

The control unit of the unmanned aerial vehicle 2b controls the driving unit in such a manner that the unmanned aerial vehicle 2b moves to the place where the unmanned aerial vehicle 2a is flying (step S12). For example, the control unit of the unmanned aerial vehicle 2b uses the position information of the unmanned aerial vehicle 2a received in step S10 to control the driving unit in such a manner that the unmanned aerial vehicle 2b moves to the place where the unmanned aerial vehicle 2a is flying. The control unit of the unmanned aerial vehicle 2b may also control the driving unit in such a manner that the unmanned aerial vehicle 2b moves straight, for example, from the standby place of the unmanned aerial vehicle 2b to the place where the unmanned aerial vehicle 2a is flying. As a result, the unmanned aerial vehicle 2b can quickly arrive at the place Where the unmanned aerial vehicle 2a is flying, and power consumption of the battery can thus be reduced.

The control unit of the unmanned aerial vehicle 2b detects the unmanned aerial vehicle 2a to be taken over (step S13). For example, the control unit of the unmanned aerial vehicle 2b performs direct wireless communication with the unmanned aerial vehicle 2a via the communication unit, and receives the ID of the unmanned aerial vehicle 2a. The control unit of the unmanned aerial vehicle 2b detects the unmanned aerial vehicle 2a to be taken over based on the ID received in step S10 and the ID received from the unmanned aerial vehicle 2a by wireless communication. The control unit of the unmanned aerial vehicle 2b may also detect the unmanned aerial vehicle 2a to be taken over by image recognition of an image captured by a camera.

When the unmanned aerial vehicle 2a to be taken over is detected, the control unit of the unmanned aerial vehicle 2b controls the driving unit so as to follow the unmanned aerial vehicle 2a for a certain period of time (step S14).

The control unit of the unmanned aerial vehicle 2b determines (recognizes) the tracking target tracked by the unmanned aerial vehicle 2a while following the unmanned aerial vehicle 2a for the certain period of time. The control unit of the unmanned aerial vehicle 2b may determine, for example, an object moving in the same direction as the unmanned aerial vehicle 2a as the tracking target tracked by the unmanned aerial vehicle 2a. The control unit of the unmanned aerial vehicle 2b may also receive tracking information of the tracking target tracked by the unmanned aerial vehicle 2a from the unmanned aerial vehicle 2a via the base stations 1a and 1b. The control unit of the unmanned aerial vehicle 2b may also directly perform wireless communication with the unmanned aerial vehicle 2a via the communication unit so as to receive the tracking information of the tracking target tracked by the unmanned aerial vehicle 2a from the unmanned aerial vehicle 2a. In this way, when the takeover of the tracking is performed, the tracking of the unmanned aerial vehicle 2a and the tracking of the unmanned aerial vehicle 2b are performed in an overlapping manner, so that the sight of the tracking target can be prevented from being lost.

When the tracking target tracked by the unmanned aerial vehicle 2a is determined, the control unit of the unmanned aerial vehicle 2b transmits a takeover preparation completion to the base station 1b (step S15).

The control unit of the unmanned aerial vehicle 2b controls the driving unit to track the tracking target taken over from the unmanned aerial vehicle 2a (step S16).

When the takeover preparation completion transmitted from the unmanned aerial vehicle 2b is received via the communication unit, the control unit of the base station 1b transmits the takeover preparation completion to the base station 1a (step S17).

When the takeover preparation completion transmitted from the base station 1b is received via the communication unit 12, the control unit 11 of the base station 1a transmits the takeover preparation completion to the unmanned aerial vehicle 2a (step S18).

When the takeover preparation completion transmitted from the base station 1a is received via the communication unit 22, the control unit 21 of the unmanned aerial vehicle 2a returns to the standby place provided in the base station 1a (step S19).

As described above, the tracking system includes the base stations 1a to 1e that form the communication areas, and the unmanned aerial vehicles 2a to 2e that belong to the base stations 1a to 1e, respectively, and fly in the communication areas of the base stations 1a to 1e so as to track the tracking target. In this case, for example, the unmanned aerial vehicle 2a transmits position information indicating the flight position of the unmanned aerial vehicle 2a to the base station 1a to which the unmanned aerial vehicle 2a belongs. The base station 1a determines the communication area which is the movement destination of the tracking target tracked by the unmanned aerial vehicle 2a based on the position information received from the unmanned aerial vehicle 2a, and transmits the tracking takeover request of the tracking target to the base station (for example, the base station 1c) which forms the determined communication area. In response to the takeover request from the base station 1a, the base station 1c transmits an instruction to start the tracking of the tracking target to the unmanned aerial vehicle 2c flying in the communication area of the base station 1c. As a result, the tracking system can track the tracking target such as a suspect over a long distance.

(Modification 1)

Although it is detected whether or not the unmanned aerial vehicles 2a to 2e are flying at the ends of the zones 3a to 3e (for example, see step S2 shown in FIG. 23) in the above description, the present disclosure is not limited thereto. The base stations 1a to 1e may detect flight of the unmanned aerial vehicles 2a to 2e at the ends of the zones 3a to 3e.

For example, the same map information as that described in step S2 shown in FIG. 23 is stored in the storage unit of each of the base stations 1a to 1e. The control units of the unmanned aerial vehicles 2a to 2e sequentially transmit, for example, the position information. acquired by the GPS reception units to the base stations 1a to 1e via the communication units. The control units of the base stations 1a to 1e determine whether or not the unmanned aerial vehicles 2a to 2e are flying at the ends of the zones 3a to 3e based on the position information transmitted from the unmanned aerial vehicles 2a to 2e and the map information stored in the storage units.

When detecting whether or not the unmanned aerial vehicles 2a to 2e are flying at the ends of the zones 3a to 3e, the unmanned aerial vehicles 2a to 2e do not need to sequentially transmit the position information to the base stations 1a to 1e. Accordingly, the unmanned aerial vehicles 2a to 2e can prevent power consumption caused by wireless communication.

(Modification 2)

Although whether or not the unmanned aerial vehicles 2a to 2e are flying at the ends of the zones 3a to 3e is determined through using the position information received by the GPS reception units (for example, see step S2 shown in FIG. 23) in the above description, the present disclosure is not limited thereto. Whether or not the unmanned aerial vehicles 2a to 2e are flying at the ends of the zones 3a to 3e may also be determined, for example, based on received power of signals received from the base stations 1a to 1e. For example, it may be determined that the unmanned aerial vehicles 2a to 2e are flying at the ends of the zones 3a to 3e when the received power of the signals received from the base stations 1a to 1e is equal to or lower than a predetermined value.

(Modification 3)

In the above description, the base stations 1a to 1e determine the movement destination zone of the tracking target based on the position information of the unmanned aerial vehicles 2a to 2e (for example, see step S5 shown in FIG. 23). The base stations 1a to 1e may further determine the movement destination zone of the tracking target based on direction information indicating moving directions of the unmanned aerial vehicles 2a to 2e in addition to the position information of the unmanned aerial vehicles 2a to 2e.

For example, when the unmanned aerial vehicle 2a moves to the end of the zone 3a, the control unit 21 of the unmanned aerial vehicle 2a calculates the moving direction of the unmanned aerial vehicle 2a based on at least two pieces of position information received by the GPS reception unit. The control unit 21 of the unmanned aerial vehicle 2a transmits movement information including the calculated moving direction to the base station 1a via the communication unit 22.

The control unit 11 of the base station 1a determines the movement destination zone of the tracking target based on the position information and the direction information of the unmanned aerial vehicle 2a transmitted from the unmanned aerial vehicle 2a. For example, when the unmanned aerial vehicle 2a flies in the region indicated by the one-dot chain line A2 shown in FIG. 20 and moves toward the zone 3c, the control unit 11 of the base station 1a determines that the zone 3c is the movement destination of the tracking target. On the other hand, when the unmanned aerial vehicle 2a is moving toward the zone 3b even though the unmanned aerial vehicle 2a is flying in the region indicated by the one-dot chain line A2 shown in FIG. 20, the control unit 11 of the base station 1a determines that the zone 3b is the movement destination of the tracking target. As a result, the control unit 11 of the base station 1a can improve determination accuracy of the zones 3a to 3e which are movement destinations of the tracking target. The base station 1a also stores map information of the zones 3b and 3c around the base station 1a.

The control unit 21 of the unmanned aerial vehicle 2a may transmit the direction information to the base station 1a without transmitting the position information to the base station 1a. The control unit 21 of the base station 1a may determine the movement destination zone of the tracking target based on the direction information transmitted from the unmanned aerial vehicle 2a.

(Modification 4)

Regarding the overlapping of the zones 3a to 3e, not only two adjacent zones 3a to 3e may overlap each other, three or more adjacent zones 3a to 3e may also overlap each other. For example, in a region indicated by an arrow A3 of FIG. 20, three zones 3a, 3b, and 3c overlap each other.

When the unmanned aerial vehicles 2a to 2e are located in a region where three or more zones 3a to 3e overlap each other, the base stations 1a to 1e may determine that all the overlapping zones 3a to 3e are the movement destination zones of the tracking target. For example, in FIG. 20, it is assumed that the unmanned aerial vehicle 2a is located in the region indicated by the arrow AS (the region in which the zones 3a, 3b, and 3c overlap each other). In this case, the control unit 11 of the base station 1a, determines that the zones 3b and 3c are the movement destination zones of the tracking target.

When the control unit 11 of the base station 1a determines the zones 3b and 3c, the unmanned aerial vehicles 2b and 2c start flying. The unmanned aerial vehicles 2b and 2c that have started flying track the unmanned aerial vehicle 2a to be taken over for the certain period of time (for example, see step S14 shown in FIG. 23). When the tracking target moves to one of the zones 3b and 3c, one of the unmanned aerial vehicles 2b and 2c can track the tracking target while the other cannot track the tracking target. The unmanned aerial vehicles 2b and 2c that can track the tracking target continue the tracking of the tracking target, and the unmanned aerial vehicles 2b and 2c that cannot track the tracking target return to the standby place.

(Modification 5)

Although the base stations 1a to 1e communicate with each other to transmit and receive information such as the takeover request, the IDs of the unmanned aerial vehicles 2a to 2e, and the position information of the unmanned aerial vehicles 2a to 2e in the above description, the present disclosure is not limited thereto. For example, the base stations 1a to 1e may transmit and receive information such as the takeover request, the IDs of the unmanned aerial vehicles 2a to 2e, and the position information of the unmanned aerial vehicles 2a to 2c via a central control device that controls the base stations 1a to 1e.

(Modification 6)

After transmitting the takeover request to the base stations 1a to 1e, the unmanned aerial vehicles 2a to 2e to be taken over may sequentially transmit the position information to the base stations 1a to 1e until receiving the takeover preparation completion from the base stations 1a to 1e. As a result, the unmanned aerial vehicles 2a to 2e which are about to take over can acquire updated position information of the unmanned aerial vehicles 2a to 2e to be taken over from a time when flight is started upon receiving the tracking start instruction from the base stations 1a to 1e until the unmanned aerial vehicles 2a to 2e which are about to take over move to the places of the unmanned aerial vehicles 2a to 2e to be taken over, and thus a time before the unmanned aerial vehicles 2a to 2e to be taken over are detected can be shortened.

(Modification 7) Although one unmanned aerial vehicle tracks the tracking target in one zone in the above description, the present disclosure is not limited thereto. In one zone, a plurality of unmanned aerial vehicles may track the tracking target.

### Embodiment 6

Since an unmanned aerial vehicle is powered by a battery, a flight time thereof is limited. Therefore, as for a patrol system using an unmanned aerial vehicle, a patrol system capable of patrol a town or the like over a long period of time is desired. In Embodiment 6, a plurality of unmanned aerial vehicles patrol in a relay manner in one communication area so as to be capable of patrolling a town or the like over a long period of time.

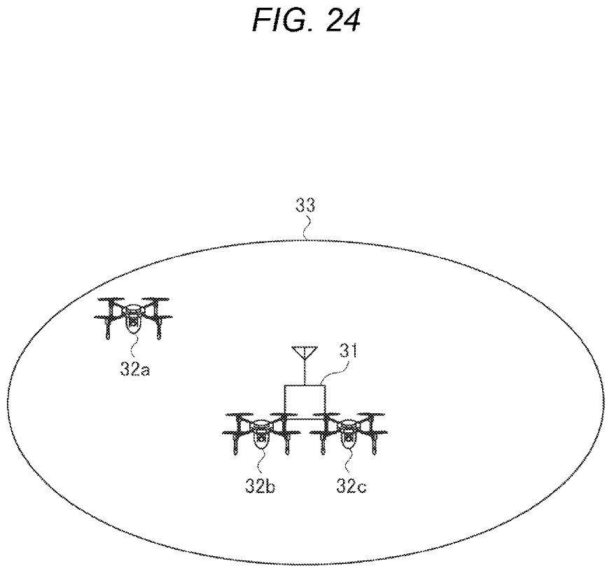

FIG. 24 shows a configuration example of a patrol system according to Embodiment 6. As shown in FIG. 24, the patrol system includes a base station 31 and unmanned aerial vehicles 32a to 32c.

The unmanned aerial vehicles 32a to 32c are, for example, drones on which cameras are mounted. The unmanned aerial vehicles 32a to 32c fly by batteries. The unmanned aerial vehicles 32a to 32c, for example, patrol While capturing images in the town with cameras. The unmanned aerial vehicles 32a to 32c may patrol along a predetermined (set) route or may autonomously patrol the town.

The base station 31 is provided, for example, on a roof of a police station. The base station 31 forms a communication area 33 in which the wireless communication with the unmanned aerial vehicles 32a to 32c is performed. The unmanned aerial vehicles 32a to 32c fly in the communication area 33 and perform wireless communication with the base station 31.

When the unmanned aerial vehicles 32a to 32c do not fly, the unmanned aerial vehicles 32a to 32c stand by in a standby place. The standby place is provided in the vicinity of the base station 31, for example, and is provided on the roof of the police station. In the standby place, for example, a charging stand that charges the batteries of the unmanned aerial vehicles 32a to 32c is provided. When the unmanned aerial vehicles 32a to 32c stand by, the batteries thereof are charged by the charging stand.

Here, since the unmanned aerial vehicles 32a to 32e fly by the batteries, it may be difficult for the unmanned aerial vehicles 32a to 32c to patrol the town over a long period of time. Therefore, in the patrol system shown in FIG. 24, the plurality of unmanned aerial vehicles 32a to 32c take turns to patrol the town.

A schematic operation example of the patrol system shown in FIG. 24 will be described. The unmanned aerial vehicle 32a flies and patrols in the town. The unmanned aerial vehicles 32b and 32c stand by in the standby place.

The unmanned aerial vehicle 32a periodically determines a remaining battery level thereof during the flight. When the remaining battery level is equal to or lower than a predetermined value, the unmanned aerial vehicle 32a transmits a flight (patrol) takeover request to the base station 31. At this time, for example, the unmanned aerial vehicle 32a uses a GPS to acquire current position information, and transmits the acquired position information to the base station 31.

Upon receiving the takeover request from the unmanned aerial vehicle 32a, the base station 31 determines an unmanned aerial vehicle to take over the patrol from among the unmanned aerial vehicles 32b and 32e which are standing by. Here, the base station 31 determines that the unmanned aerial vehicle 32b is the unmanned aerial vehicle to take over the patrol.

When the base station 31 determines the unmanned aerial vehicle 32b to take over the patrol, the base station 31 transmits the takeover request to the unmanned aerial vehicle 32b. At this time, the base station 31 also transmits the position information received from the unmanned aerial vehicle 32a to be taken over to the unmanned aerial vehicle 32b that takes over the patrol.

Upon receiving the takeover request from the base station 31, the unmanned aerial vehicle 32b flies to a position indicated by the position information received from the base station 31. That is, the unmanned aerial vehicle 32b flies to a place where the unmanned aerial vehicle 32a is flying. Upon arriving at the position indicated by the position information, the unmanned aerial vehicle 32b starts the patrol in place of the unmanned aerial vehicle 32a. The unmanned aerial vehicle 32a that hands over the patrol to the unmanned aerial vehicle 32b returns to the standby place of the unmanned aerial vehicle 32a.

The unmanned aerial vehicle 32b which takes over the patrol also periodically determines a remaining battery level thereof. When the remaining battery level is equal to or lower than a predetermined value, the unmanned aerial vehicle 32b transmits the flight takeover request to the base station 31. Upon receiving the takeover request from the unmanned aerial vehicle 32b, the base station 31 determines an unmanned aerial vehicle to take over the patrol from among the unmanned aerial vehicles 32a and 32c which are standing by.

As described above, the unmanned aerial vehicles 32a to 32c which patrol the town periodically determine the remaining battery level, and hand over the patrol to the unmanned aerial vehicles 32a to 32c that are standing by when the remaining battery level is equal to or lower than the predetermined value. As a result, the patrol system shown in FIG. 24 can patrol the town over the long period of time.

The base station 31 may be connected to an information processing device of a police center or a mobile terminal carried by a police officer. The base station 31 may receive images captured by the cameras of the unmanned aerial vehicles 32a to 32c and transmit the images to the information processing device of the police center or the mobile terminal possessed by the police officer.

The base station 31 has the same block configuration as that of the base station 1a shown in FIG. 21. The unmanned aerial vehicles 32a to 32c have the same block configuration as that of the unmanned aerial vehicle 2a shown in FIG. 22. Each of the unmanned aerial vehicles 32a to 32c has the same function.

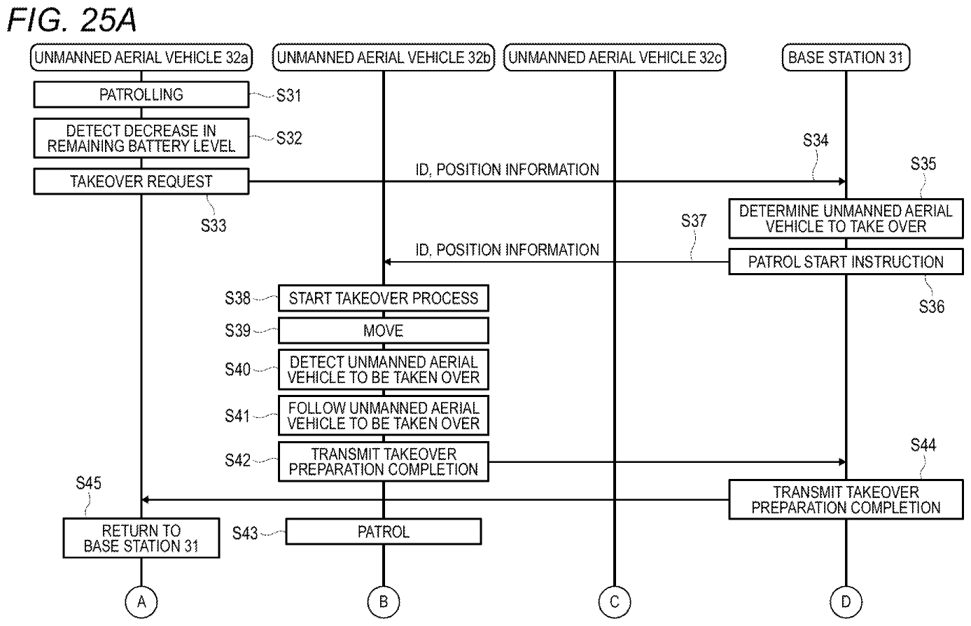

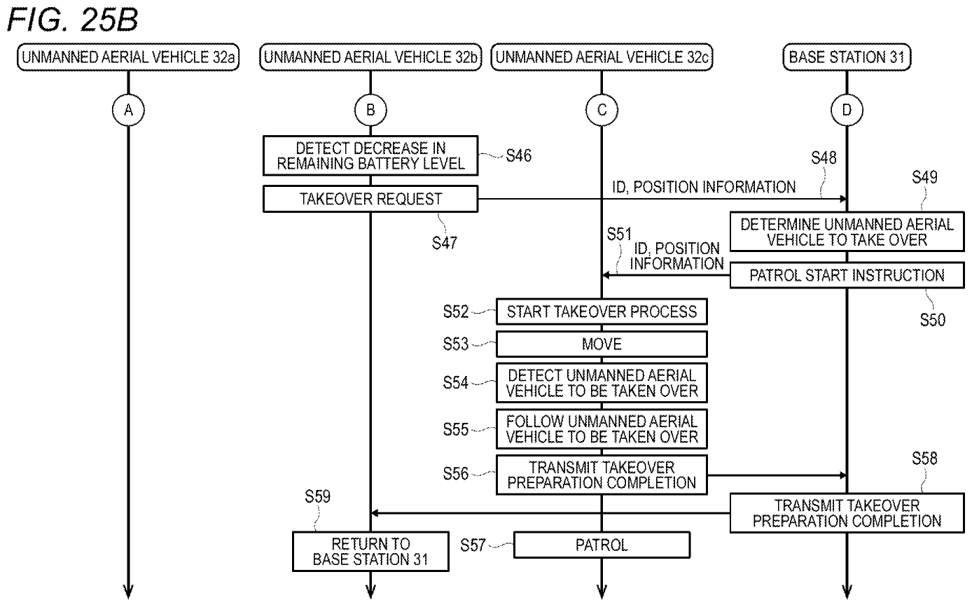

FIGS. 25A and 25B are sequence charts showing an operation example of the patrol system. The control unit of the unmanned aerial vehicle 32a controls the driving unit in such a manner that the unmanned aerial vehicle 32a patrols the town (step S31). For example, the storage unit of the unmanned aerial vehicle 32a stores in advance information on a patrol route (for example, latitude and longitude) along which the unmanned aerial vehicle 32a patrols. The control unit of the unmanned aerial vehicle 32a controls the driving unit to patrol along the patrol route stored in the storage unit. The control unit of the unmanned aerial vehicle 32a may also control the driving unit to autonomously patrol the town.

The control unit of the unmanned aerial vehicle 32a detects a decrease in the remaining battery level (step S32). For example, the control unit of the unmanned aerial vehicle 32a periodically acquires a voltage of the battery. When the voltage of the battery is equal to or lower than a predetermined value, the control unit of the unmanned aerial vehicle 32a detects the decrease in the remaining battery level.

Upon detecting the decrease in the remaining battery level, the control unit of the unmanned aerial vehicle 32a transmits the takeover request to the base station 31 via the communication unit (step S33). When the takeover request is transmitted to the base station 31, the control unit of the unmanned aerial vehicle 32a acquires the position information from the GPS reception unit. The control unit of the unmanned aerial vehicle 32a transmits the position information acquired from the GPS reception unit and an ID of the unmanned aerial vehicle 32a to the base station 31.

The control unit of the base station 31 receives the takeover request, the ID of the unmanned aerial vehicle 32a, and the position information of the unmanned aerial vehicle 32a from the unmanned aerial vehicle 32a via the communication unit (step S34).

Upon receiving the takeover request from the unmanned aerial vehicle 32a, the control unit of the base station 31 determines an unmanned aerial vehicle to take over the patrol from among the unmanned aerial vehicles 32b and 32c which are standing by in the standby place (step S35). For example, the control unit of the base station 31 may determine an unmanned aerial vehicle standing by for a longest time (an unmanned aerial vehicle that has flown at an earliest time) as the unmanned aerial vehicle to take over the patrol. In this case, the control unit of the base station 31 determines that the unmanned aerial vehicle 32b is the unmanned aerial vehicle to take over the patrol.

When the unmanned aerial vehicle 32b is determined to take over the patrol, the control unit of the base station 31 transmits a patrol start instruction to the unmanned aerial vehicle 32b (step S36). When the patrol start instruction is transmitted to the unmanned aerial vehicle 32b, the control unit of the base station 31 transmits the ID of the unmanned aerial vehicle 32a and the position information of the unmanned aerial vehicle 32a received in step S34 to the unmanned aerial vehicle 32b.

The control unit of the unmanned aerial vehicle 32b receives the patrol start instruction, the ID of the unmanned aerial vehicle 32a, and the position information of the unmanned aerial vehicle 32a from the base station 31 via the communication unit (step S37).

Upon receiving the patrol start instruction from the base station 31, the control unit of the unmanned aerial vehicle 32b starts a takeover process (step S38). For example, the control unit of the unmanned aerial vehicle 32b controls the driving unit to start flight.

The control unit of the unmanned aerial vehicle 32b controls the driving unit in such a manner that the unmanned aerial vehicle 32b moves to the place where the unmanned aerial vehicle 32a is flying (step S39). For example, the control unit of the unmanned aerial vehicle 32b uses the position information of the unmanned aerial vehicle 32a received in step S37 to control the driving unit in such a manner that the unmanned aerial vehicle 32b moves to the place where the unmanned aerial vehicle 32a is flying. The control unit of the unmanned aerial vehicle 32b may also control the driving unit in such a manner that the unmanned aerial vehicle 32b moves straight, for example, from the standby place of the unmanned aerial vehicle 32b to the place where the unmanned aerial vehicle 32a is flying. As a result, the unmanned aerial vehicle 32b can quickly arrive at the place where the unmanned aerial vehicle 32a is flying, and power consumption of the battery can thus be reduced.

The control unit of the unmanned aerial vehicle 32b detects the unmanned aerial vehicle 32a to be taken over (step S40). For example, the control unit of the unmanned aerial vehicle 32b performs direct wireless communication with the unmanned aerial vehicle 32a via the communication unit, and receives the ID of the unmanned aerial vehicle 32a. The control unit of the unmanned aerial vehicle 32b detects the unmanned aerial vehicle 32a to be taken over based on the ID received in step S37 and the ID received from the unmanned aerial vehicle 32a by wireless communication. The control unit of the unmanned aerial vehicle 32b may also detect the unmanned aerial vehicle 32a to be taken over by image recognition of an image captured by a camera.

When the unmanned aerial vehicle 32a to be taken over is detected, the control unit of the unmanned aerial vehicle 32b controls the driving unit so as to follow the unmanned aerial vehicle 32a for a certain period of time (step S41). As described above, when the patrol is taken over, the patrol system overlaps the patrol of the unmanned aerial vehicle 32a and the patrol of the unmanned aerial vehicle 32b with each other, so that omission of the patrol (a blank time of the patrol) can be prevented.

When the unmanned aerial vehicle 32a is followed for the certain period of time, the control unit of the unmanned aerial vehicle 32b transmits a takeover preparation completion to the base station 31 (step S42).

The control unit of the unmanned aerial vehicle 32b controls the driving unit in such a manner that the unmanned aerial vehicle 32b patrols the town (step S43).

When the takeover preparation completion transmitted from the unmanned aerial vehicle 32b is received via the communication unit, the control unit of the base station 31 transmits the takeover preparation completion to the unmanned aerial vehicle 32a to be taken over (step S44).

When the takeover preparation completion transmitted from the base station 31 is received via the communication unit, the control unit of the unmanned aerial vehicle 32a controls the driving unit such that the unmanned aerial vehicle 32a returns to the standby place provided in the base station 31 (step S45).

The control unit of the unmanned aerial vehicle 32b detects a decrease in the remaining battery level (step S46). For example, the control unit of the unmanned aerial vehicle 32b periodically acquires a voltage of the battery. When the voltage of the battery is equal to or lower than a predetermined value, the control unit of the unmanned aerial vehicle 32b detects the decrease in the remaining battery level.

Upon detecting the decrease in the remaining battery level, the control unit of the unmanned aerial vehicle 32b transmits the takeover request to the base station 31 via the communication unit (step S47). When the takeover request is transmitted to the base station 31, the control unit of the unmanned aerial vehicle 32b acquires the position information from the GPS reception unit. The control unit of the unmanned aerial vehicle 32b transmits the position information acquired from the GPS reception unit and an ID of the unmanned aerial vehicle 32b to the base station 31.

The control unit of the base station 31 receives the takeover request, the ID of the unmanned aerial vehicle 32b, and the position information of the unmanned aerial vehicle 32b from the unmanned aerial vehicle 32b via the communication unit (step S48).

Upon receiving the takeover request from the unmanned aerial vehicle 32b, the control unit of the base station 31 determines an unmanned aerial vehicle to take over the patrol from among the unmanned aerial vehicles 32a and 32c which are standing by in the standby place (step S49). For example, the control unit of the base station 31 may determine an unmanned aerial vehicle standing by for a longest time (an unmanned aerial vehicle that has flown at an earliest time) as the unmanned aerial vehicle to take over the patrol. Since the unmanned aerial vehicle 32c has stood by for a longer time than the unmanned aerial vehicle 32a, the control unit of the base station 31 determines the unmanned aerial vehicle 32c as the unmanned aerial vehicle to take over the patrol.

When the unmanned aerial vehicle 32c is determined to take over the patrol, the control unit of the base station 31 transmits the patrol start instruction to the unmanned aerial vehicle 32c (step S50). When the patrol start instruction is transmitted to the unmanned aerial vehicle 32c, the control unit of the base station 31 transmits the ID of the unmanned aerial vehicle 32b and the position information of the unmanned aerial vehicle 32b received in step S48 to the unmanned aerial vehicle 32c.

The control unit of the unmanned aerial vehicle 32c receives the patrol start instruction, the ID of the unmanned aerial vehicle 32b, and the position information of the unmanned aerial vehicle 32b from the base station 31 via the communication unit (step S51).

Upon receiving the patrol start instruction from the base station 31, the control unit of the unmanned aerial vehicle 32c starts a takeover process (step S52). For example, the control unit of the unmanned aerial vehicle 32c controls the driving unit to start flight.

The control unit of the unmanned aerial vehicle 32c controls the driving unit in such a manner that the unmanned aerial vehicle 32c moves to the place where the unmanned aerial vehicle 32b is flying (step S53). For example, the control unit of the unmanned aerial vehicle 32c uses the position information of the unmanned aerial vehicle 32b received in step S51 to control the driving unit in such a manner that the unmanned aerial vehicle 32c moves to the place where the unmanned aerial vehicle 32b is flying,. The control unit of the unmanned aerial vehicle 32c may also control the driving unit in such a manner that the unmanned aerial vehicle 32c moves straight, for example, from the standby place of the unmanned aerial vehicle 32c to the place where the unmanned aerial vehicle 32b is flying. As a result, the unmanned aerial vehicle 32c can quickly arrive at the place where the unmanned aerial vehicle 32b is flying, and thus power consumption of the battery can also be reduced.

The control unit of the unmanned aerial vehicle 32c detects the unmanned aerial vehicle 32b to be taken over (step S54). For example, the control unit of the unmanned aerial vehicle 32c performs direct wireless communication with the unmanned aerial vehicle 32b via the communication unit, and receives the ID of the unmanned aerial vehicle 32b. The control unit of the unmanned aerial vehicle 32c detects the unmanned aerial vehicle 32b to be taken over based on the ID received in step S51 and the ID received from the unmanned aerial vehicle 32b by wireless communication. The control unit of the unmanned aerial vehicle 32c may also detect the unmanned aerial vehicle 32b to be taken over by image recognition of an image captured by a camera.

When the unmanned aerial vehicle 32b to be taken over is detected, the control unit of the unmanned aerial vehicle 32c controls the driving unit to follow the unmanned aerial vehicle 32b for a certain period of time (step S55). As described above, when the patrol is taken over, the patrol system overlaps the patrol of the unmanned aerial vehicle 32b and the patrol of the unmanned aerial vehicle 32c with each other, so that the omission of the patrol (the blank time of the patrol) can be prevented.

When the unmanned aerial vehicle 32b is followed for the certain period of time, the control unit of the unmanned aerial vehicle 32c transmits the takeover preparation completion to the base station 31 (step S56).

The control unit of the unmanned aerial vehicle 32c controls the driving unit in such a manner that the unmanned aerial vehicle 32c patrols the town (step S57).

When the takeover preparation completion transmitted from the unmanned aerial vehicle 32c is received via the communication unit, the control unit of the base station 31 transmits the takeover preparation completion to the unmanned aerial vehicle 32b to be taken over (step S58).

When the takeover preparation completion transmitted from the base station 31 is received via the communication unit, the control unit of the unmanned aerial vehicle 32b controls the driving unit in such a manner that the unmanned aerial vehicle 32b returns to the standby place provided in the base station 31 (step S59).

As described above, the patrol system includes the base station 31 that forms the communication area and the unmanned aerial vehicles 32a to 32c that fly in the communication area of the base station 31. When the remaining battery level is equal to or lower than the predetermined value, the unmanned aerial vehicles 32a to 32c transmit the flight takeover request to the base station 31 during the flight. When the takeover request is received from the unmanned aerial vehicles 32a to 32c during the flight, the base station 31 transmits the flight start instruction to the unmanned aerial vehicles 32a to 32c which are standing by for flight. The unmanned aerial vehicles 32a to 32c standing by for the flight start flight in response to the flight start instruction from the base station 31. As a result, the patrol system can patrol the town or the like over the long period of time.

(Modification 1)

The standby place of the unmanned aerial vehicles 32a to 32c may be provided at different places in the communication area 33 of the base station 31 (may be provided in the communication area 33 in a distributed manner). In this case, the control unit of the base station 31 may determine the unmanned aerial vehicles 32a to 32c which are about to take over from among the unmanned aerial vehicles 32a to 32c that are standing by in a standby place closest to a flight position of the unmanned aerial vehicles 32a to 32c to be taken over. As a result, the unmanned aerial vehicles 32a to 32c which are about to take over can quickly arrive at the place where the unmanned aerial vehicles 32a to 32c to be taken over are flying, and thus the power consumption of the battery can be reduced.

(Modification 2)

Although the patrol system causes the unmanned aerial vehicles 32a to 32c to fly one by one in the above description, a plurality of unmanned aerial vehicles may fly at the same time. In this case, the plurality of unmanned aerial vehicles flying at the same time may patrol along different patrol routes, respectively.

When the plurality of unmanned aerial vehicles fly at the same time, the patrol system may dynamically change the number of the unmanned aerial vehicles flying at the same time. For example, the patrol system may change the number of the unmanned aerial vehicles flying at the same time between nighttime and daytime. For example, the patrol system may set the number of unmanned aerial vehicles patrolling at nighttime to be more than the number of unmanned aerial vehicles patrolling during daytime.

(Modification 3)

The control unit of each of the unmanned aerial vehicles 32a to 32c to be taken over may further transmit, to the base station 31, direction information indicating a moving direction of each of the unmanned aerial vehicles 32a to 32c in addition to the position information of the unmanned aerial vehicles 32a to 32c. The base station 31 may transmit the position information and the direction information received from the unmanned aerial vehicles 32a to 32c to be taken over to the unmanned aerial vehicles 32a to 32c which are about to take over. The unmanned aerial vehicles 32a to 32c which are about to take over may move toward the unmanned aerial vehicles 32a to 32c to be taken over based on the position information and the moving direction received from the base station 31. As a result, even if the unmanned aerial vehicles 32a to 32e of to be taken over move from the position indicated by the position information before the unmanned aerial vehicles 32a to 32c which are about to take over arrive at the position indicated by the position information, the unmanned aerial vehicles 32a to 32c which are about to take over can search for the unmanned aerial vehicles 32a to 32c to be taken over based on the moving direction.

(Modification 4)

After transmitting the takeover request to the base station 31, the unmanned aerial vehicles 32a to 32c to be taken over may sequentially transmit the position information to the base stations 31 until the takeover preparation completion is received from the base stations 31. As a result, the unmanned aerial vehicles 32a to 32c which are about to take over can acquire updated position information of the unmanned aerial vehicles 32a to 32c to be taken over from a time when flight is started upon receiving the patrol start instruction from the base stations 31 until the unmanned aerial vehicles 32a to 32c which are about to take over move to the places of the unmanned aerial vehicles 32a to 32c to be taken over, and thus a time before the unmanned aerial vehicles 32a to 32c to be taken over are detected can be shortened.

### Embodiment 7

A patrol system may use a vehicle and an unmanned aerial vehicle to patrol a town or the like. In this case, it is desired that the patrol system causes the unmanned aerial vehicle to patrol along a patrol route which does not overlap a patrol route already patrolled by the vehicle. A patrol system according to Embodiment 7 is configured such that a route along which a vehicle patrols and a route along which an unmanned aerial vehicle patrols do not overlap each other, so that a town is finely patrolled.

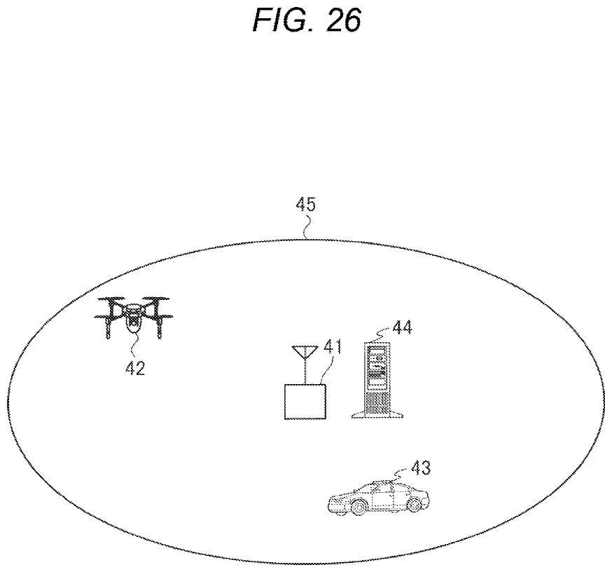

FIG. 26 shows a configuration example of a patrol system according to Embodiment 7. As shown in FIG. 26, the patrol system includes a base station 41, an unmanned aerial vehicle 42, a vehicle 43, and an information processing device 44.

The unmanned aerial vehicle 42 is, for example, a drone equipped with a camera. The unmanned aerial vehicle 42 flies by a battery. The unmanned aerial vehicle 42, for example, patrols while capturing an image of the town with the camera. The unmanned aerial vehicle 42 patrols along a predetermined route. The unmanned aerial vehicle 42 sequentially transmits position information of the unmanned aerial vehicle 42 to the base station 41. The predetermined route may be indicated by, for example, a latitude and a longitude.

The base station 41 is provided, for example, on a roof of a police station. The base station 41 forms a communication area 45. The unmanned aerial vehicle 42 flies in the communication area 45 and performs wireless communication with the base station 41. The base station 41 transmits the position information received from the unmanned aerial vehicle 42 to the information processing device 44.

The vehicle 43 is, for example, a police vehicle. The vehicle 43 is equipped with an in-vehicle camera and patrols the town. A patrol route of the vehicle 43 may or may not be determined in advance. Even when the patrol route of the vehicle 43 is determined in advance, the patrol route is freely changed according to intention of a driver.

The vehicle 43 is equipped with a control box (CB). The CB of the vehicle 43 sequentially acquires a position of the vehicle 43 and transmits position information of the acquired position to the information processing device 44.

The information processing device 44 is a server that manages the patrol routes of the unmanned aerial vehicle 42 and the vehicle 43. The information processing device 44 is provided in, for example, a police station. The information processing device 44 communicates with the vehicle 43 via, for example, a network (not shown) such as a wireless communication network or the Internet. The information processing device 44 also communicates with the base station 41 via a network such as the Internet.

In this case, the patrol route of the vehicle 43 is not determined. Even if the patrol route of the vehicle 43 is determined, the patrol route may be changed according to the intention of the driver. Therefore, the patrol route along which the vehicle 43 has patrolled may overlaps with a non-flying route within the predetermined route of the unmanned aerial vehicle 42 along which the unmanned aerial vehicle 42 does not patrol (fly) yet (hereinafter, the route along which the vehicle 43 has patrolled may be referred to as a travel route). If the travel route of the vehicle 43 overlaps with the non-flying route along which the unmanned aerial vehicle 42 is going to patrol, the unmanned aerial vehicle 42 will patrol along a route along which the vehicle 43 has already patrolled, which results in vainly patrol. Moreover, the patrol system is not able to perform patrol covering the town.

Therefore, when the travel route of the vehicle 43 overlaps with the non-flying route of the unmanned aerial vehicle 42, the patrol system shown in FIG. 26 changes a portion of the non-flying route which overlaps with the travel route to a route along which the vehicle 43 does not patrol (travel).

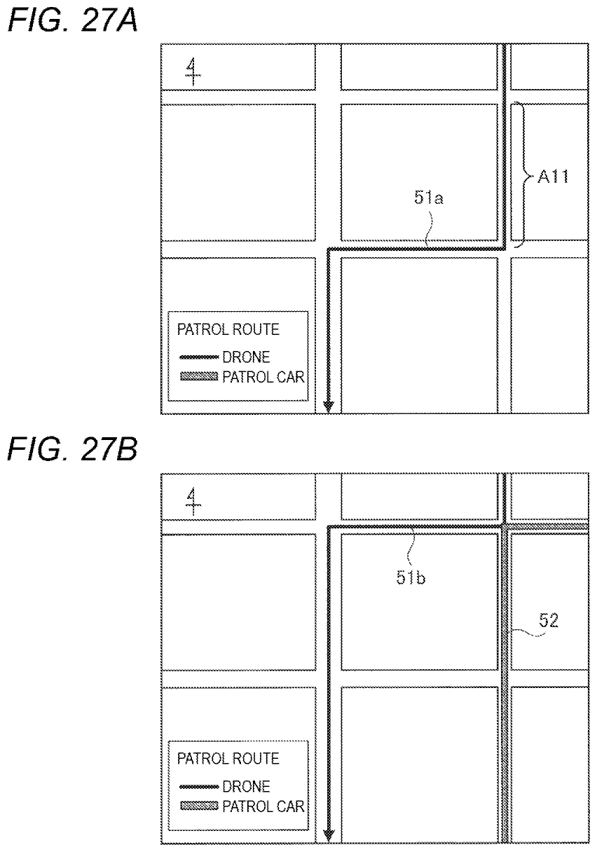

A schematic operation example of the patrol system shown in FIG. 26 will be described with reference to FIGS. 27A and 27B. FIGS. 27A and 27B show a schematic operation example of the patrol system. Maps of a town are shown in FIGS. 27A and 27B. The map shown in FIG. 27A and the map shown in FIG. 27B are the same.

A predetermined route 51a shown in FIG. 27A indicates a route along which the unmanned aerial vehicle 42 patrols. The unmanned aerial vehicle 42 patrols the town in accordance with the predetermined route 51a. It is assumed that the unmanned aerial vehicle 42 has not yet patrolled along the predetermined route 51a shown in FIG. 27A. That is, the predetermined route 51a shown in FIG. 27A is still the non-flying route.

A travel route 52 shown in FIG. 27B indicates a route along which the vehicle 43 has patrolled. The travel route 52 overlaps with the predetermined route 51a (non-flying route) of the unmanned aerial vehicle 42 in a section A11 shown in FIG. 27A.

When the travel route 52 along which the vehicle 43 has patrolled overlaps with the non-flying route (the predetermined route 51a shown in FIG. 27A) of the unmanned aerial vehicle 42, the information processing device 44 changes a portion of the non-flying route which overlaps with the travel route 52 to a route along which the vehicle 43 does not patrol. For example, the information processing device 44 changes the route along which the unmanned aerial vehicle 42 patrols as indicated by a predetermined route 51b shown in FIG. 27B.

As described above, the patrol system changes the patrol route of the unmanned aerial vehicle 42 when the travel route 52 along which the vehicle 43 has patrolled overlaps with the non-flying route of the unmanned aerial vehicle 42. As a result, the patrol system can cause the unmanned aerial vehicle 42 to patrol without overlapping the travel route of the vehicle 43.

The base station 41 may be connected to an information processing device of a police center or a mobile terminal carried by a police officer. The base station 41 may receive an image captured by the camera of the unmanned aerial vehicles 42 and transmit the image to the information processing device of the police center or the mobile terminal carried by the police officer.

The base station 41 has the same block configuration as that of the base station 1a shown in FIG. 21. The unmanned aerial vehicle 42 has the same block configuration as that of the unmanned aerial vehicle 2a shown in FIG. 22.

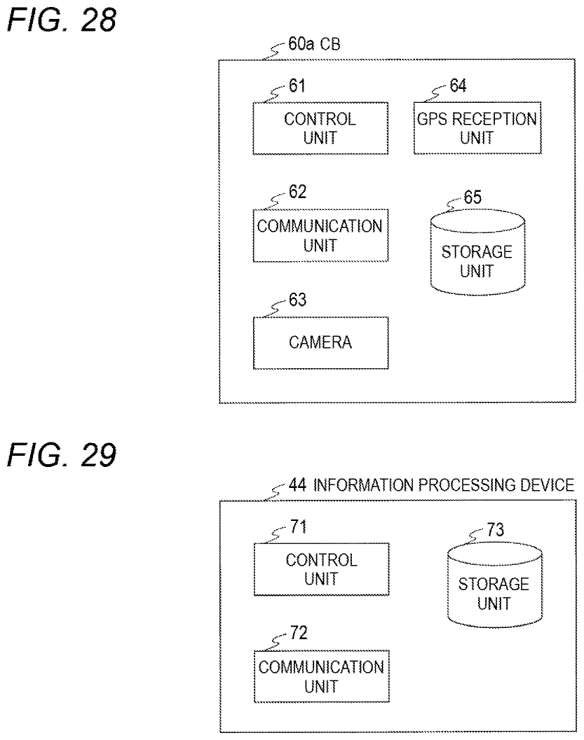

FIG. 28 shows a block configuration example of the CB 60a of the vehicle 43. As shown in FIG. 28, the CB 60a of the vehicle 43 includes a control unit 61, a communication unit 62, a camera 63, a GPS reception unit 64, and a storage unit 65.

The control unit 61 controls the entire CB 60a. The control unit 61 may be configured by, for example, a CPU.

The communication unit 62 communicates with the information processing device 44 via, for example, a network such as a wireless communication network or the Internet. The camera 63 includes an optical lens, a lens control mechanism, an image sensor, and the like. The camera 63 outputs image data of a captured image to the control unit 61.

The GPS reception unit 64 receives GPS signals transmitted from a plurality of GPS satellites, and uses the received GPS signals to calculate a current position of the vehicle 43. The current position includes, for example, a latitude and a longitude.

The storage unit 65 stores a program for operating the control unit 61. Data for the control unit 61 to perform calculation processing, or data for the control unit 61 to control each unit is stored in the storage unit 65. The storage unit 65 may be configured by a storage device such as a RAM, a ROM, a flash memory, or an HDD.

FIG. 29 shows a block configuration example of the information processing device 44. As shown in FIG. 29, the information processing device 44 includes a control unit 71, a communication unit 72, and a storage unit 73.

The control unit 71 controls the entire information processing device 44. The control unit 71 may be configured by, for example, a CPU.

The communication unit 72 communicates with the base station 41 via a network such as the Internet, for example. The communication unit 72 communicates with the CB 60a of the vehicle 43 via, for example, a network such as a wireless communication network or the Internet.

The storage unit 73 stores a program for operating the control unit 71. Data for the control unit 71 to perform calculation processing, or data for the control unit 71 to control each unit is stored in the storage unit 73. The storage unit 73 may be configured by a storage device such as a RAM, a ROM, a flash memory, or an HDD.

A function of the information processing device 44 may also be implemented by a patrol car position information system.

Fie. 30 is a sequence chart showing an operation example of the patrol system. For example, when a patrol start instruction is received from the information processing device (not shown) in the police station, the control unit of the base station 41 transmits the predetermined route of the unmanned aerial vehicle 42 to the unmanned aerial vehicle 42 and the information processing device 44 (step S71). The predetermined route may be stored in the storage unit of the base station 41. The control unit of the base station 41 may transmit the predetermined route stored in the storage unit to the unmanned aerial vehicle 42 and the information processing device 44. The information processing device in the police station may transmit the predetermined route to the base station 41. The control unit of the base station 41 may transmit the predetermined route received from the information processing device in the police station to the unmanned aerial vehicle 42 and the information processing device 44.

The control unit of the unmanned aerial vehicle 42 stores the predetermined route transmitted from the base station 41 in the storage unit (step S72). When the predetermined route is stored in the storage unit, the control unit of the unmanned aerial vehicle 42 controls the driving unit in such a manner that the unmanned aerial vehicle 42 patrols the town in accordance with the predetermined route stored in the storage unit.

The control unit 71 of the information processing device 44 stores the predetermined route transmitted from the base station 41 in the storage unit 73 (step S73).

The control unit 61 of the CB 60a acquires the position information from the GPS reception unit 64 and transmits the acquired position information to the information processing device 44 via the communication unit 62 (step S74).

The control unit 71 of the information processing device 44 updates the travel route of the vehicle 43 based on the position information transmitted from the CB 60a (step S75). For example, the control unit 71 of the information processing device 44 stores the position information transmitted from the CB 60a in the storage unit 73, and manages the stored position information as the travel route along which the vehicle 43 has traveled (patrolled).

The control unit 61 of the CB 60a acquires the position information from the GPS reception unit 64 and transmits the acquired position information to the information processing device 44 via the communication unit 62 (step S76).

The control unit 71 of the information processing device 44 updates the travel route of the vehicle 43 based on the position information transmitted from the CB 60a (step S77).

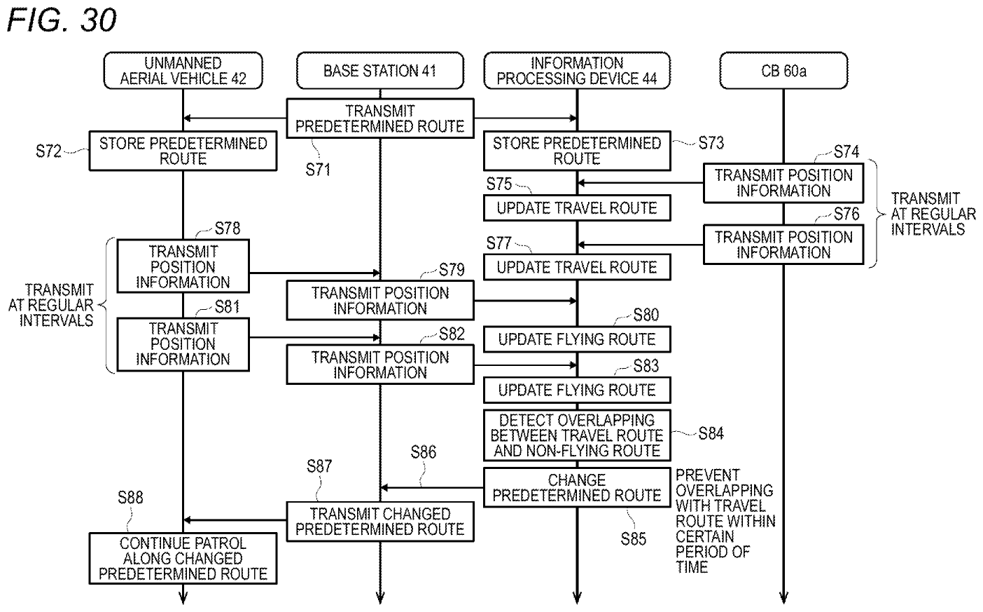

Although the control unit 61 of the GB 60a transmits the position information twice in steps S74 and S76 in FIG. 30, the position information is transmitted to the information processing device 44 at regular intervals until the patrol of the vehicle 43 is ended. The control unit 71 of the information processing device 44 updates the travel route of the vehicle 43 based on the position information transmitted from the CB 60a.

The control unit of the unmanned aerial vehicle 42 acquires the position information from the GPS reception unit and transmits the acquired position information to the base station 41 via the communication unit (step S78)..

The control unit of the base station 41 transmits the position information transmitted from the unmanned aerial vehicle 42 to the information processing device 44 via the communication unit (step S79).

The control unit 71 of the information processing device 44 updates a flying route of the unmanned aerial vehicle 42 (a route along which the unmanned aerial vehicle 42 has patrolled) based on the position information transmitted from the base station 41 (step S80). For example, the control unit 71 of the information processing device 44 stores the position information transmitted from the base station 41 in the storage unit 73, and manages the stored position information as the flying route along which the unmanned aerial vehicle 42 has flown.

The control unit of the unmanned aerial vehicle 42 acquires the position information from the GPS reception unit and transmits the acquired position information to the base station 41 via the communication unit (step S81).

The control unit of the base station 41 transmits the position information transmitted from the unmanned aerial vehicle 42 to the information processing device 44 via the communication unit (step S82).

The control unit 71 of the information processing device 44 updates the flying route of the unmanned aerial vehicle 42 based on the position information transmitted from the base station 41 (step S83).

Although the control unit of the unmanned aerial vehicle 42 transmits the position information twice in steps S78 and S81 in FIG. 30, the position information is transmitted to the information processing device 44 at regular intervals until the patrol of the unmanned aerial vehicle 42 is ended. The control unit 71 of the information processing device 44 updates the flying route of the unmanned aerial vehicle 42 based on the position information transmitted from the unmanned aerial vehicle 42.

The control unit 71 of the information processing device 44 detects an overlap between the travel route and the non-flying route (step S84).

The control unit 71 of the information processing device 44 changes the predetermined route such that a portion of the non-flying route which overlaps the travel route is changed to a route along which the vehicle 43 does not patrol (step S85).

Although not shown in FIG. 30, the control unit 71 of the information processing device 44 determines the overlap between the travel route and the non-flying route at regular intervals. The control unit 71 of the information processing device 44 can also acquire the non-flying route based on the predetermined route and the flying route. For example, the control unit 71 of the information processing device 44 sets a route obtained by excluding the flying route from the predetermined route as the non-flying route.

The control unit 71 of the information processing device 44 transmits the changed predetermined route (hereinafter, referred to as the changed predetermined route) to the base station 41 via the communication unit 72 (step S86).

The control unit of the base station 41 transmits the changed predetermined route transmitted from the information processing device 44 to the unmanned aerial vehicle 42 (step S87).

The control unit of the unmanned aerial vehicle 42 updates the predetermined route stored in the storage unit to the changed predetermined route transmitted from the base station 41, and controls the driving unit to patrol the town based on the updated changed predetermined route (step S88).

As described above, the patrol system includes the vehicle 43, the information processing device 44, and the unmanned aerial vehicle 42 that performs patrol flight along the predetermined route. The information processing device 44 sequentially receives the position information indicating a travel position of the vehicle 43 from the vehicle 43, and acquires the travel route of the vehicle 43. The information processing device 44 sequentially receives the position information indicating a flight position of the unmanned aerial vehicle 42 from the unmanned aerial vehicle 42, and acquires the non-flying route within the predetermined route along which the unmanned aerial vehicle 42 has not flown yet. When the travel route overlaps the with the non-flying route, the information processing device 44 changes the portion of the non-flying route which overlaps with the travel route to the route along which the vehicle 43 does not travel. As a result, the patrol system can cause the unmanned aerial vehicle 42 to patrol without overlapping the travel route of the vehicle 43. Moreover, the patrol system can prevent vainly patrol and perform the patrol covering the town.

(Modification 1)

A wearable camera may be added to the above-described patrol system. The wearable camera is worn or carried by a police officer, for example.

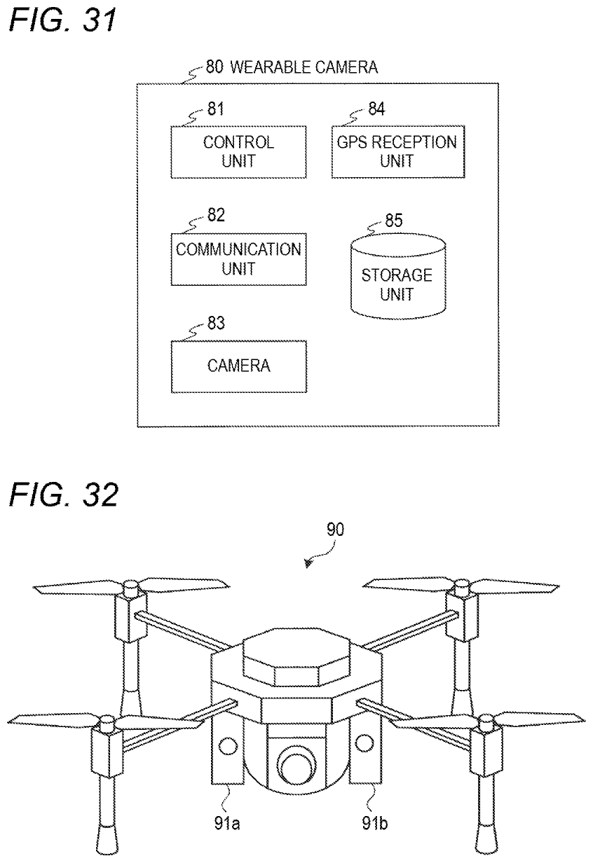

FIG. 31 shows a block configuration example of a wearable camera 80. As shown in FIG. 31, the wearable camera 80 includes a control unit 81, a communication unit 82, a camera 83, a GPS reception unit 84, and a storage unit 85.

The control unit 81 controls the entire wearable camera 80. The control unit 81 may be configured by, for example, a CPU.

The communication unit 82 communicates with the information processing device 44 via, for example, a network such as a wireless communication network or the Internet. The camera 83 includes an optical lens, a lens control mechanism, an image sensor, and the like. The camera 83 outputs image data of a captured image to the control unit 81.

The GPS reception unit 84 receives GPS signals transmitted from a plurality of GPS satellites, and uses the received GPS signals to calculate a current position of the wearable camera 80. The current position includes, for example, a latitude and a longitude.

The storage unit 85 stores a program for operating the control unit 81. Data for the control unit 81 to perform calculation processing, or data for the control unit 81 to control each unit is stored in the storage unit 85. The storage unit 85 may be configured by a storage device such as a RAM, a ROM, a flash memory, or an HDD.

The control unit 71 of the information processing device 44 changes the flying route of the unmanned aerial vehicle 42 based on a patrol route of the wearable camera 80 in the same manner as the case of the vehicle 43. For example, the control unit 71 of information processing device 44 sequentially receives position information of the wearable camera 80 from the wearable camera 80, and acquires a route (hereinafter, may be referred to as a moving route) along Which the wearable camera 80 has moved (patrolled).

In a case where the moving route of the wearable camera 80 overlaps with the non-flying route of the unmanned aerial vehicle 42, the information processing device 44 changes a portion of the non-flying route which overlaps with the moving route to a route along which the wearable camera 80 does not move.

As a result, the patrol system can cause the unmanned aerial vehicle 42 to patrol without overlapping the moving route of the wearable camera 80. Moreover, the patrol system can prevent vainly patrol and perform the patrol covering the town.

(Modification 2)

Although there is one unmanned aerial vehicle and one vehicle patrolling the town in the above description, the present disclosure is not limited thereto. There may be a plurality of unmanned aerial vehicles and a plurality of vehicles patrolling the town..

### Embodiment 8

A flying speed of an unmanned aerial vehicle is limited. Therefore, a tracking target such as a suspect who moves beyond the flying speed may be missed. In Embodiment 8, a projectile is launched to the tracking target that moves beyond the flying speed of the unmanned aerial vehicle so as to intimidate the tracking target.

FIG. 32 shows an example of appearance of the unmaimed aerial vehicle according to Embodiment 8. As shown in FIG. 32, an unmanned aerial vehicle 90 includes launching units 91a and 91b. Projectiles are launched from the launching units 91a and 91b. For example, electrons are emitted (irradiated) from the launching unit 91a. A transmitter attached with a magnet is launched from the launching unit 91b. The transmitter transmits position information of the transmitter to, for example, an information processing device of a police center or a mobile terminal carried by a police officer. The unmanned aerial vehicle 90 includes the same blocks as those of the unmanned aerial vehicle 2a shown in FIG. 22.

In this case, a flying speed of the unmanned aerial vehicle 90 is limited. Therefore, when the tracking target moves (escapes) at a speed exceeding the flying speed of the unmanned aerial vehicle 90, the unmanned aerial vehicle 90 cannot track the tracking target. Therefore, when a distance between the unmanned aerial vehicle 90 and the tracking target is equal to or higher than a predetermined value, the unmanned aerial vehicle 90 launches the projectiles from the launching units 91a and 91b to intimidate the tracking target.

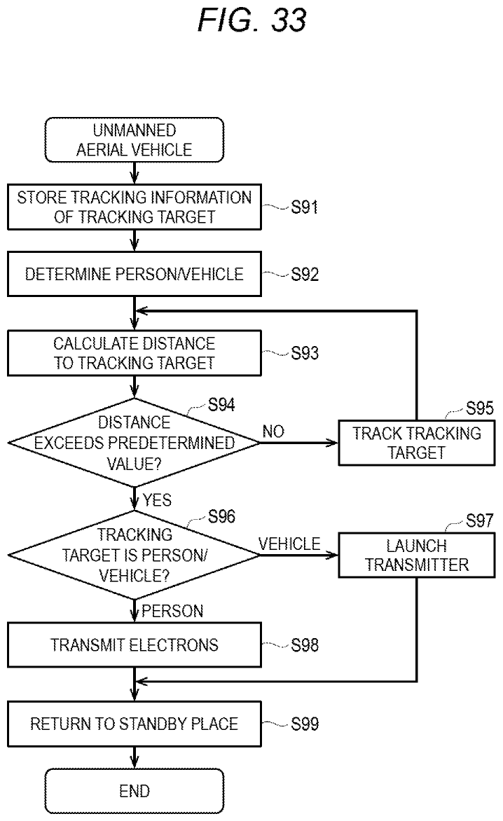

FIG. 33 is a flowchart showing an operation example of the unmanned aerial vehicle. The control unit of the unmanned aerial vehicle 90 stores tracking information of the tracking target in the storage unit (step S91). The tracking information (feature amount) of the tracking target is transmitted from, for example, the information processing device of the police center or the mobile terminal carried by the police officer.

The control unit of the unmanned aerial vehicle 90 determines whether the tracking target is a person or a vehicle based on the tracking information stored in the storage unit (step S92). For example, the control unit of the unmanned aerial vehicle 90 determines that the tracking target is a person when the tracking information stored in the storage unit matches a feature amount of a person. On the other hand, the control unit of the unmanned aerial vehicle 90 determines that the tracking target is a vehicle when the tracking information stored in the storage unit matches a feature amount of a vehicle.

The control unit of the unmanned aerial vehicle 90 calculates a distance from the unmanned aerial vehicle 90 to the tracking target((step S93). For example, the control unit of the unmanned aerial vehicle 90 analyzes image data of an image captured by a camera, and calculates the distance from the unmanned aerial vehicle 90 to the tracking target.

The control unit of the unmanned aerial vehicle 90 determines whether the distance calculated in step S93 exceeds a predetermined value (step S94). The predetermined value is at least set to a distance at which the projectiles launched from the launching units 91a and 91b can reach the tracking target. When it is determined that the distance calculated in step S93 does not exceed the predetermined value (“No” in S94), the control unit of the unmanned aerial vehicle 90 continues the tracking of the tracking target (step S95), and the process proceeds to step S93.

On the other hand, when it is determined that the distance calculated in step S93 exceeds the predetermined value (“Yes” in S94), the control unit of the unmanned aerial vehicle 90 determines whether a determination result determined in step S92 is a person or a vehicle (step S96). When the tracking target is a vehicle, the control unit of the unmanned aerial vehicle 90 launches the transmitter attached with the magnet toward the vehicle (step S97). As a result, the transmitter attached with the magnet can be attached to a body of the vehicle, and thus the escaping vehicle can be tracked by the transmitter, for example.

On the other hand, when the tracking target is a person, the control unit of the unmanned aerial vehicle 90 emits the electrons toward the person (step S98). As a result, escape of the person can be prevented.

When the projectiles are launched in step S97 or step S98, the control unit of the unmanned aerial vehicle 90 controls the driving unit to return the unmanned aerial vehicle 90 to a standby place (step S99).

As described above, the camera of the unmanned aerial vehicle 90 captures an image of the tracking target. The control unit of the unmanned aerial vehicle 90 calculates the distance to the tracking target based on the image of the tracking target captured by the camera. When the distance calculated by the control unit exceeds a predetermined value, the launching units 91a and 91b of the unmanned aerial vehicle 90 launch the projectiles toward the tracking target. As a result, when the distance to the tracking target exceeds the predetermined value, the unmanned aerial vehicle 90 launches the projectiles to intimidate the tracking target. Moreover, when the tracking target is a person, the unmanned aerial vehicle 90 emits the electrons, and thus the person can be prevented from escaping. When the tracking target is a vehicle, the unmanned aerial vehicle 90 launches the transmitter, and thus the vehicle can be tracked from the transmitter.

(Modification 1)

The control unit of the unmanned aerial vehicle 90 may cause the launching units 91a and 91b to launch the projectiles when the distance to the tracking target exceeds the predetermined value for a certain or longer period of time. As a result, for example, even if the distance to the tracking target temporarily exceeds the predetermined value, the launching units 91a and 91b of the unmanned aerial vehicle 90 do not need to launch the projectiles to the tracking target which gives up the escape thereafter.

(Modification 2)

The control unit of the unmanned aerial vehicle 90 may cause the launching units 91a and 91b to launch the projectiles when the speed of the unmanned aerial vehicle 90 exceeds a predetermined value. For example, the predetermined value is set to a value smaller than a maximum speed of the unmanned aerial vehicle 90 and close to the maximum speed of the unmanned aerial vehicle 90. Specifically, the predetermined value is set to a speed between 90% of the maximum speed and the maximum speed. As a result, the launching units 91a and 91b of the unmanned aerial vehicle 90 can launch the projectiles while the unmanned aerial vehicle 90 is capable of tracking the tracking target.

(Modification 3)

Although the unmanned aerial vehicle 90 includes the two launching units 91a and 91b in the above description, the unmanned aerial vehicle 90 may include one launching unit or three or more launching units. The control unit of the unmanned aerial vehicle 90 may launch different projectiles from a plurality of launching units in accordance with features of the person to be tracked. The projectiles launched from the launching units 91a and 91b are not limited to the electrons or the transmitter. For example, a net that captures the person or a ball containing ink may be launched.

(Modification 4)

Although the control unit of the unmanned aerial vehicle 90 analyzes the image captured by the camera to calculate the distance between the unmanned aerial vehicle 90 and the tracking target in the above description, the present disclosure is not limited thereto. For example, the unmanned aerial vehicle 90 may include a measurement device that irradiates the tracking target with light such as a laser so as to measure the distance based on reflected light from the tracking target. Specifically, the control unit of the unmanned aerial vehicle 90 controls the measurement device so as to irradiate the tracking target with light output from the measurement device based on the image of the camera. Then the control unit of the unmanned aerial vehicle 90 may acquire the distance to the tracking target measured by the measurement device.

The unmanned aerial vehicle 90 may also include a measurement device that irradiates the tracking target with a sound such as an ultrasonic wave so as to measure the distance based on a reflected sound from the tracking target. Specifically, the control unit of the unmanned aerial vehicle 90 controls the measurement device so as to irradiate the tracking target with a sound output from the measurement device based on the image of the camera. Then the control unit of the unmanned aerial vehicle 90 may acquire the distance to the tracking target measured by the measurement device.

The embodiments described above may be combined. For example, Embodiment 5 and Embodiment 6 may be combined. For example, in one zone, when the remaining battery level of the unmanned aerial vehicle that tracks the tracking target is equal to or lower than the predetermined value, another unmanned aerial vehicle may track the tracking target. Embodiment 6 and Embodiment 7 may also be combined. For example, the unmanned aerial vehicle may patrols without overlapping the route along which the vehicle has patrolled during the patrol of the unmanned aerial vehicle performed in the relay manner. Embodiments 5 to 7 may also be combined with Embodiment 8. For example, the unmanned aerial vehicle according to each of Embodiments 5 to 7 may be provided with the launching function of Embodiment 8.

Functions of each device such as the BWC 10, the ICV 20, the drone 30, the center server 40, the PC 50, the mobile terminal 70, the base station 1a, the unmanned aerial vehicle 2a, the information processing device 44, the CB 60a, and the wearable camera 80 described above may be implemented by computer programs.

The present disclosure may be implemented by software, hardware, or software in cooperation with hardware.

Each functional block used in the description of the above embodiments may be partially or entirely implemented as an LSI which is an integrated circuit. Each process described in the above embodiments may be partially or entirely controlled by one LSI or a combination of LSIs. The LSI may be configured by individual chips, or may be configured by one chip so as to include a part or all of the functional blocks. The LSI may include input and output of data. The LSI may be referred to as an IC, a system LSI, a super LSI, or an ultra LSI depending on a degree of integration.

The method of circuit integration is not limited to the LSI, and may also be implemented by a dedicated circuit, a general-purpose processor, or a dedicated processor. Moreover, after the LSI is manufactured, a field programmable gate array (FPGA) that can be programmed or a reconfigurable processor that can reconfigure a connection and a setting of circuit cells in the LSI may be used. The present disclosure may be implemented as digital processing or analog processing.

Further, if an integrated circuit technology that replaces the LSI emerges due to a progress of a semiconductor technology or another derivative technology, the technology may naturally be used to integrate the functional blocks. Application of biotechnology or the like may also be possible.

The communication includes not only data communication implemented by a cellular system, a wireless LAN system, a communication satellite system, or the like, but also data communication implemented by a combination thereof.

(Supplementary Note 1) A security system includes an unmanned aerial vehicle that is operable in a plurality of different modes and transmits an image captured by a camera, and a terminal that displays the image transmitted from the unmanned aerial vehicle, information on the modes of the unmanned aerial vehicle, and a user interface (UI) including an operation interface of the unmanned aerial vehicle.

(Supplementary Note 2)

The security system according to Supplementary Note 1, in which the unmanned aerial vehicle

when the operation interface is operated, switches to a manual mode in which the unmanned aerial vehicle operates in accordance with the operation, and

when a position is specified on the image, switches to a tracking mode in which the unmanned aerial vehicle tracks a target imaged at the position.

(Supplementary Note 3)

The security system according to Supplementary Note 2, in which, when the unmanned aerial vehicle loses sight of the target from the image in the tracking mode, the unmanned aerial vehicle transmits a notification indicating that the sight of the target is lost to the terminal, and switches to the manual mode.

(Supplementary Note 4)

The security system according to Supplementary Note 2, in which the unmanned aerial vehicle records the image during the tracking mode.

(Supplementary Note 5)

The security system according to Supplementary Note 2, in which the unmanned aerial vehicle is switched to a patrol mode in which the unmanned aerial vehicle patrols along. a predetermined route when the operation interface is not operated for a predetermined or longer period of time in the manual mode.

(Supplementary Note 6)

A security method includes

transmitting an image captured by a camera from an unmanned aerial vehicle operable in a plurality of different modes, and

displaying, on a terminal, the image transmitted from the unmanned aerial vehicle, information on the modes of the unmanned aerial vehicle, and a user interface (UI) having an operation interface of the unmanned aerial vehicle.

(Supplementary Note 7)

A tracking system includes:

a first base station that forms a first communication area,

a first unmanned aerial vehicle that flies in the first communication area,

a second base station that forms a second communication area, and

a second unmanned aerial vehicle that flies in the second communication area.

The first unmanned aerial vehicle transmits position information indicating a flight position of the first unmanned aerial vehicle to the first base station.

The first base station determines the second communication area which is a movement destination of a tracking target tracked by the first unmanned aerial vehicle based on the position information, and transmits a tracking takeover request of the tracking target to the second base station forming the second communication area.

The second base station transmits a tracking start instruction of the tracking target to the second unmanned aerial vehicle in response to the takeover request.

(Supplementary Note 8)

The tracking system according to Supplementary Note 7, in which the first unmanned aerial vehicle transmits the position information to the first base station when the first unmanned aerial vehicle flies at a position where the first communication area and the second communication area overlap each other.

(Supplementary Note 9)

The tracking system according to Supplementary Note 7, in which the second unmanned aerial vehicle flies to a place where the first unmanned aerial vehicle is flying based on the position information, detects the first unmanned aerial vehicle, and then transmits takeover completion information to the second base station.

The second base station transmits the takeover completion information to the first base station.

The first base station transmits the takeover completion information to the first unmanned aerial vehicle, and

the first unmanned aerial vehicle returns to a predetermined place in response to reception of the takeover completion information.

(Supplementary Note 10)

The tracking system according to Supplementary Note 9, in which the second unmanned aerial vehicle follows the first unmanned aerial vehicle for a predetermined time after detecting the first unmanned aerial vehicle and then transmits the takeover completion information to the second base station.

(Supplementary Note 11)

The tracking system according to Supplementary Note 7, in which the first unmanned aerial vehicle transmits direction information indicating a moving direction of the tracking target to the first base station when transmitting the position information, and the first base station determines the second communication area which is a movement destination of the tracking target tracked by the first unmanned aerial vehicle based on the position information and the direction information.

(Supplementary Note 12)

A patrol system includes

a base station that forms a communication area, and

a plurality of unmanned aerial vehicles flying in the communication area.

The unmanned aerial vehicle flying in the communication area transmits a flight takeover request to the base station when a remaining battery level thereof is equal to or lower than a predetermined value.

Upon receiving the takeover request, the base station transmits a flight start instruction to a unmanned aerial vehicle standing by for flight, and

the unmanned aerial vehicle standing by for the flight starts the flight in response to the flight start instruction.

(Supplementary Note 13)

The patrol system according to Supplementary Note 12, in which the unmanned aerial vehicle flying in the communication area transmits position information indicating a flight position to the base station when transmitting the takeover request.

The base station transmits the position information to the unmanned aerial vehicle standing by for the flight when transmitting the flight start instruction, and

the unmanned aerial vehicle standing by for the flight starts the flight in response to the flight start instruction and then flies to the position indicated by the position information.

(Supplementary Note 14)

The patrol system according to Supplementary Note 13, in which the unmanned aerial vehicle standing by for the flight flies to a place where the unmanned aerial vehicle flying in the communication area is flying based on the position information after starting the flight in response to the flight start instruction, detects the unmanned aerial vehicle flying in the communication area, and then transmits takeover completion information to the base station.

The base station transmits the takeover completion information to the unmanned aerial vehicle flying in the communication area, and

the unmanned aerial vehicle flying in the communication area returns to a predetermined place in response to reception of the takeover completion information.

(Supplementary Note 15)

The patrol system according to Supplementary Note 14, in which the unmanned aerial vehicle standing by for the flight detects the unmanned aerial vehicle flying in the communication area, then follows the unmanned aerial vehicle flying in the communication. area for a predetermined time, and transmits the takeover completion information to the base station.

(Supplementary Note 16)

The patrol system according to Supplementary Note 13, in which the unmanned aerial vehicle flying in the communication area transmits direction information indicating a flight direction to the base station when transmitting the takeover request, and the base station transmits the position information and the direction information to the unmanned aerial vehicle standing by for the flight, and

the unmanned aerial vehicle standing by for the flight flies to a place where the unmanned aerial vehicle flying in the communication area is flying based on the position information and the direction information.

(Supplementary Note 17)

A patrol system includes

a vehicle,

an unmanned aerial vehicle that performs patrol flight along a predetermined route, and

an information processing device.

The information processing device sequentially receives travel position information indicating a travel position of the vehicle from the vehicle and acquires a travel route of the vehicle.

The information processing device sequentially receives flight position information indicating a flight position of the unmanned aerial vehicle from the unmanned aerial vehicle, and acquires a non-flying route within the predetermined route along which the unmanned aerial vehicle has not flown yet.

When the travel route overlaps with the non-flying route, the information processing device changes a portion of the non-flying route which overlaps with the travel route to a route along which the vehicle does not travel.

(Supplementary Note 18)

The patrol system according to Supplementary Note 17, in which the information processing device sequentially receives movement position information indicating a movement position of the wearable camera from the wearable camera, and acquires a movement route of the wearable camera.

When the movement route overlaps with the non-flying route, the information processing device changes a portion of the non-flying route which overlaps with the movement route to a route along which the wearable camera does not move.

(Supplementary Note 19)

An unmanned aerial vehicle that tracks a tracking target includes

a camera that captures an image of the tracking target,

a calculation unit that calculates a distance to the tracking target based on the image of the tracking target captured by the camera, and

a launching unit that launches a projectile toward the tracking target when the distance exceeds a predetermined value.

(Supplementary Note 20)

The unmanned aerial vehicle according to Supplementary Note 19 further includes a determination unit that determines a type of the tracking target based on a feature amount of the tracking target.

When the distance exceeds the predetermined value, the launching unit launches one of a first projectile and a second projectile toward the tracking target in accordance with the type.

Disclosed contents of specifications, drawings, and abstracted included in Japanese Patent Application No. 2018-193520 filed on Oct. 12, 2018, Japanese Patent Application No. 2018-221120 filed on Nov. 27, 2018, and Japanese Patent Application No. 2018-221127 filed on Nov. 27, 2018 are incorporated by reference in the present application.

### INDUSTRIAL APPLICABILITY

An aspect of the present disclosure is useful for a system related to security.

### REFERENCE SIGNS LIST

1 security system
10 body-worn camera (BWC)
20 in car video system (ICV)
30 drone
40 center server
50 PC
60 license plate recognition (LPR) camera
70 mobile terminal
1a to 1e, 31, 41 base station
2a to 2e, 32a to 32c, 42, 90 unmanned aerial vehicle
3a to 3e zone
11, 21, 61, 71, 81 control unit
12, 13, 22, 27, 62, 72, 82 communication unit
14, 28, 65, 73, 85 storage unit
23, 63, 83 camera
24, 64, 84 GPS reception unit
25 driving unit
26 battery
33, 45 communication area
vehicle
44 information processing device
60a CB
80 wearable camera
91a, 91b launching unit

1. A security system comprising:
a wearable camera that is configured to record a captured first image and is wearable by a person;
an unmanned aerial vehicle that is configured to record a second image captured by a camera mounted thereon; and
a control device that is configured to acquire a position of the wearable camera and transmit a first instruction to the unmanned aerial vehicle, the first instruction indicating start of a recording of the second image and movement toward the position of the wearable camera.

2. The security system according to claim 1, wherein
the control device transmits the first instruction to the unmanned aerial vehicle when the wearable camera starts a recording of the first image.

3. The security system according to claim 1, wherein
the control device transmits the first instruction to the unmanned aerial vehicle when a warning light of a vehicle on which the unmanned aerial vehicle is mounted is turned on while the vehicle is stopped.

4. The security system according to claim 2, wherein
the control device transmits a second instruction to the unmanned aerial vehicle when the wearable camera stops the recording of the first image, the second instruction indicating stop and return of the recording of the second image.

5. The security system according to claim 1, wherein
the control device includes a recording ID in the first instruction, the recording ID being associated with the recording of the first image, and
the unmanned aerial vehicle associates the recording ID included in the first instruction with the recording of the second image.

6. The security system according to claim 5, wherein
when event information is input by a police officer, the control device manages the recording of the first and second images, which is associated with the input or selected recording ID, in association with the event information.

7. A security method of a control device, the security method comprising:
acquiring a position of a wearable camera configured to record a captured first image, the wearable being wearable by a person, and
transmitting a first instruction to an unmanned aerial vehicle configured to record a second image captured by a camera mounted thereon, the first instruction indicating start of a recording of the second image and movement toward the position of the wearable camera.
